(19) United States
(12) Patent Application Publication
(10) Pub. No.: US 2021/0182440 A1
(43) Pub. Date: Jun. 17, 2021

(54) SYSTEM FOR PREVENTING ACCESS TO SENSITIVE INFORMATION AND RELATED TECHNIQUES

(71) Applicant: Citrix Systems, Inc., Fort Lauderdale, FL (US)

(72) Inventor: Manbinder Pal Singh, Fort Lauderdale, FL (US)

(21) Appl. No.: 16/716,761

(22) Filed: Dec. 17, 2019

(51) Int. Cl. G06F 21/84; G06F 3/01; G06K 9/00; G06N 20/00

(52) U.S. Cl. CPC G06F 21/84; G06N 20/00; G06K 9/00288; G06F 3/011

(57) ABSTRACT

Techniques are disclosed for context-aware sensitive content leak prevention. An example methodology implementing the techniques includes, responsive to a determination that sensitive content is being displayed on a first device, determining whether a second device is proximate the first device, the second device having at least one recording means. The method also includes, responsive to a determination that the second device is proximate the first device, causing disabling of the at least one recording means on the second device to thereby prevent the sensitive content from being recorded using the at least one recording means of the second device. The at least one recording means may include one of a camera, an audio recorder, or an image capture device. In some cases, the second device may be a mobile device.

### BACKGROUND

Confidential, proprietary, or otherwise sensitive content may be accessed using a variety of devices, both personal and professional. For example, an organization may store confidential documents in cloud/network storage or access confidential information using one or more Software-as-a-Service (SaaS) or remote desktop applications. An organization may grant its employees, contractors, agents, partners, or other persons associated with organization permission to access various types of content over the network, including word processing documents, spreadsheets, image files, text files, and Portable Document Format (PDF) files.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one example embodiment provided to illustrate the broader concepts, systems, and techniques described herein, a method may include, responsive to a determination that sensitive content is being displayed on a first device, determining, by the first device, whether a second device is proximate the first device, the second device having at least one recording means and, responsive to a determination that the second device is proximate the first device, causing, by the first device, disabling of the at least one recording means on the second device to thereby prevent the sensitive content from being recorded using the at least one recording means of the second device.

In one aspect, the at least one recording means includes a camera.

In one aspect, the at least one recording means includes an audio recorder.

In one aspect, the at least one recording means includes an image capture device.

In one aspect, determining whether the second device is proximate the first device includes determining whether the second device is within a security zone associated with the first device.

In one aspect, determining whether the second device is proximate the first device includes determining whether a user of the second device is proximate the first device using facial recognition.

In one aspect, the method may also include, responsive to a determination that the second device is no longer proximate the first device, causing enabling of the at least one recording means on the second device.

According to another illustrative embodiment provided to illustrate the broader concepts described herein, a system includes a memory and one or more processors in communication with the memory. The processor may be configured to, responsive to a determination that sensitive content is being displayed on a first device, determine whether a second device is proximate the first device, the second device having at least one recording means and, responsive to a determination that the second device is proximate the first device, cause the at least one recording means on the second device to be disabled to thereby prevent the sensitive content from being recorded using the at least one recording means of the second device.

In one aspect, the at least one recording means includes one of a camera, an audio recorder, or an image capture device.

In one aspect, the second device is a mobile device.

In one aspect, to determine whether the second device is proximate the first device includes to determine whether the second device is within a security zone associated with the first device.

In one aspect, to determine whether the second device is proximate the first device includes to determine whether a user of the second device is proximate the first device via facial recognition.

In one aspect, the processor may be also configured to, responsive to a determination that the second device is no longer proximate the first device, cause the at least one recording means on the second device to be enabled.

According to another illustrative embodiment provided to illustrate the broader concepts described herein, a method may include, responsive to a determination that sensitive content is being displayed on a first device, determining, by the first device, whether a second device is proximate the first device and, responsive to a determination that the second device is proximate the first device, preventing, by the first device, loss of the sensitive content via use of the second device.

In one aspect, determining whether the second device is proximate the first device includes determining whether a camera of the second device is used based on machine learning.

In one aspect, the second device has at least one recording means, and wherein preventing loss of the sensitive content includes causing disabling of the at least one recording means on the second device to thereby prevent the sensitive content from being recorded using the at least one recording means of the second device.

In one aspect, the at least one recording means includes one of a camera or an audio recorder.

In one aspect, preventing loss of the sensitive content includes deleting an image file on the second device.

In one aspect, preventing loss of the sensitive content includes providing a notification on the first device.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 depicts an illustrative computer system architecture that may be used in accordance with one or more illustrative aspects of the concepts described herein.

FIG. 2 depicts an illustrative remote-access system architecture that may be used in accordance with one or more illustrative aspects of the concepts described herein.

FIG. 3 depicts an illustrative virtualized (hypervisor) system architecture that may be used in accordance with one or more illustrative aspects of the concepts described herein.

FIG. 4 is a schematic block diagram of a cloud computing environment in which various aspects of the disclosure may be implemented.

FIG. 5 depicts an illustrative enterprise mobility management system, in accordance with an embodiment of the present disclosure.

FIG. 6 depicts an illustrative enterprise computing device management system, in accordance with an embodiment of the present disclosure.

FIG. 7 is a block diagram illustrating selective components of an example computing device in which various aspects of the disclosure may be implemented, in accordance with an embodiment of the present disclosure.

FIG. 8 is a diagram illustrating an example computing environment in which context-aware sensitive content leak prevention may be implemented, in accordance with an embodiment of the present disclosure.

FIG. 9 is a diagram illustrating an example context-aware sensitive content leak prevention process, in accordance with an embodiment of the present disclosure.

FIG. 10 illustrates an example flow of interactions between various components to detect entry into and exit from a security zone, in accordance with an embodiment of the present disclosure.

FIG. 11 illustrates an example flow of interactions between various components to disable a recording means on a device to prevent leak of sensitive content, in accordance with an embodiment of the present disclosure.

FIG. 12 illustrates an example flow of interactions between various components to enable a recording means on a device, in accordance with an embodiment of the present disclosure.

FIG. 13 illustrates an example flow of interactions between various components to enable a recording means on a device, in accordance with an embodiment of the present disclosure.

FIG. 14 illustrates an example flow of interactions between various components to disable a recording means on a device to prevent leak of sensitive content, in accordance with an embodiment of the present disclosure.

FIG. 15 illustrates an example flow of interactions between various components to disable a recording means on a device to prevent leak of sensitive content, in accordance with an embodiment of the present disclosure.

FIG. 16 illustrates an example flow of interactions between various components to delete a file storing an image of sensitive content on a device to prevent leak of sensitive content, in accordance with an embodiment of the present disclosure.

### DETAILED DESCRIPTION

When sensitive content is displayed, for example on a display device, the displayed sensitive content may be intended to be viewed only by a specific individual or individuals. However, when sensitive content is displayed, there is a risk that such displayed sensitive content may be leaked or otherwise compromised. For example, unauthorized persons nearby the display may be able to view the sensitive content being displayed on the display device.

Concepts, devices, and techniques are disclosed for context-aware content leak prevention. In embodiments, the content may be sensitive content. The contexts that determine the application of leak prevention as disclosed herein may include, but are not limited to, determination that sensitive content is being displayed on a computing device and detecting another computing device proximate the computing device displaying the sensitive content. Such contexts provide an indication of the vulnerability of the displayed sensitive content to potential data leak or loss. For example, in some cases, the prevention may be to disable the recording means of the computing device proximate the computing device displaying the sensitive content. In other cases, the prevention may be to delete a recording of the sensitive content, such as an image of the sensitive content, taken using a recording means of the computing device proximate the computing device displaying the sensitive content. In any case, the prevention may also include providing a notification on the computing device displaying the sensitive content of the potential data leak. The techniques disclosed herein reduce or effectively eliminate the potential for data leakage or loss caused by computing devices being proximate a computing device that is displaying sensitive content. These and other advantages, configurations, modifications, and embodiments will be apparent in light of this disclosure.

The term “sensitive content”, or “sensitive information”, or “confidential content”, or “confidential information” is herein used synonymously to include any content or information that is either legally confidential or identified by an individual/organization as being only intended to be seen/viewed by the user themselves, or intended to be seen/viewed any one or more other persons authorized by this user. Other terms may also be used to refer to content or information that is either legally confidential/sensitive or identified by an individual/organization as being only for the eyes of the user themselves, or any one or more other persons authorized by this user. Non-limiting examples of sensitive content include any data that could potentially be used to identify a particular individual (e.g., a full name, Social Security number, driver's license number, bank account number, passport number, and email address), financial information regarding an individual/organization, information deemed confidential by the individual/organization (e.g., contracts, sales quotes, customer contact information, phone numbers, personal information about employees, and employee compensation information), and information classified by a governing authority as being confidential.

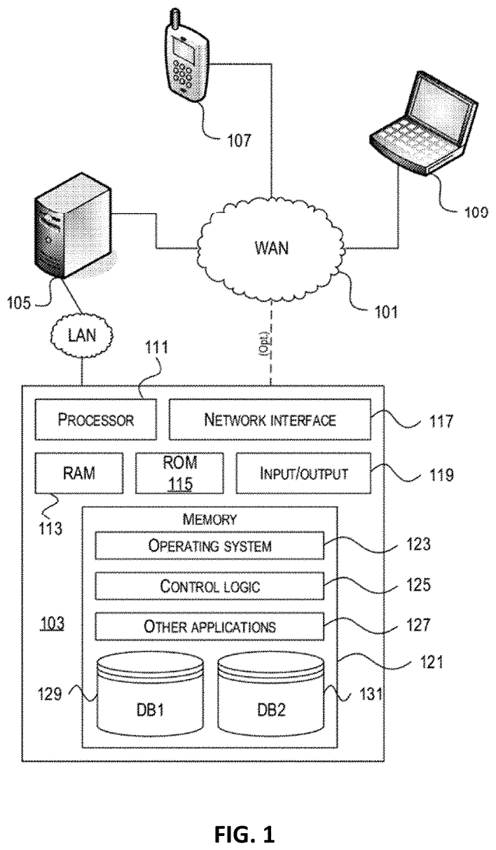

Referring now to FIG. 1, shown is one example of a system architecture and data processing device that may be used to implement one or more illustrative aspects of the concepts described herein in a standalone and/or networked environment. As shown, various network node devices 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topologies and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components and devices which make up the system of FIG. 1 may include a data server 103, a web server 105, and client computers 107, 109. Data server 103 provides overall access, control and administration of databases and control software for performing one or more illustrative aspects of the concepts described herein. Data server 103 may be connected to web server 105 through which users interact with and obtain data as requested. Alternatively, data server 103 may act as a web server itself and be directly connected to the Internet. Data server 103 may be connected to web server 105 through local area network 133, wide area network 101 (e.g., the Internet), via direct or indirect connection, or via some other network. Users may interact with data server 103 using remote computers 107, 109, e.g., using a web browser to connect to data server 103 via one or more externally exposed web sites hosted by web server 105. Client computers 107, 109 may be used in concert with data server 103 to access data stored therein or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used in the system architecture and data processing device of FIG. 1, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of data server 103. Data server 103 may further include a random access memory (RAM) 113, a read only memory (ROM) 115, a network interface 117, input/output interfaces 119 (e.g., keyboard, mouse, display, printer, etc.), and a memory 121. Input/output (I/O) interfaces 119 may include a variety of interface units and drives for reading, writing, displaying, and/or printing data or files. Memory 121 may store operating system software 123 for controlling overall operation of the data server 103, control logic 125 for instructing data server 103 to perform aspects of the concepts described herein, and other application software 127 providing secondary, support, and/or other functionality which may or might not be used in conjunction with aspects of the concepts described herein. Control logic 125 may also be referred to herein as the data server software. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects of the concepts described herein. Memory 121 may include, for example, a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, and 109 may have similar or different architecture as described with respect to data server 103. Those of skill in the art will appreciate that the functionality of data server 103 (or device 105, 107, or 109) as described herein may be spread across multiple data processing devices, for example, to distribute processing load across multiple computers, to segregate transactions based on geographic location, user access level, quality of service (QoS), etc.

One or more aspects of the concepts described here may be embodied as computer-usable or readable data and/or as computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution or may be written in a scripting language such as (but not limited to) Hypertext Markup Language (HTML) or Extensible Markup Language (XML). The computer executable instructions may be stored on a computer readable storage medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source node and a destination node (e.g., the source node can be a storage or processing node having information stored therein which information can be transferred to another node referred to as a “destination node”). The media can be transferred in the form of electromagnetic waves traveling through signal-conducting media such as metal wires, optical fibers, and/or wireless transmission media (e.g., air and/or space). Various aspects of the concepts described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects of the concepts described herein, and such data structures are contemplated within the scope of computer executable instructions and computer-usable data described herein.

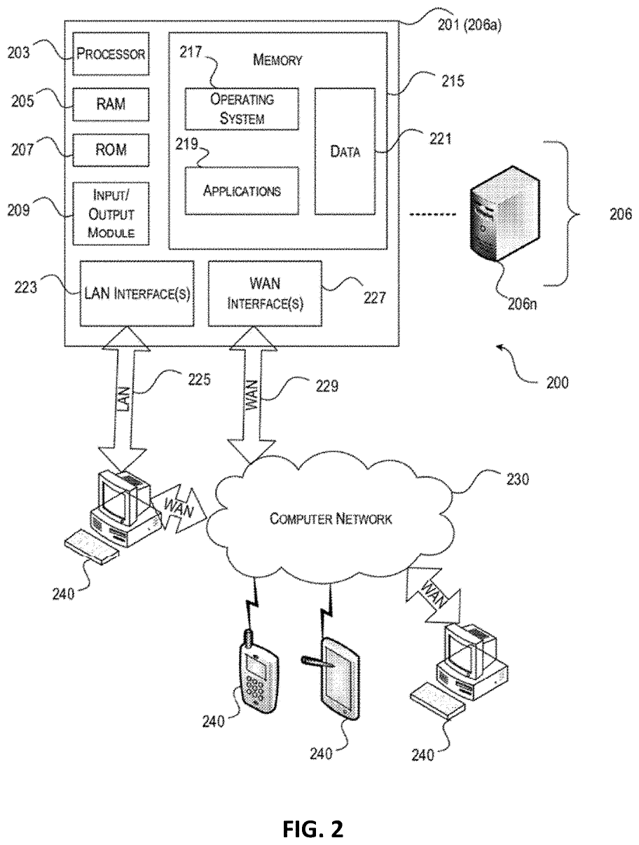

With further reference to FIG. 2, one or more aspects of the concepts described herein may be implemented in a remote-access environment. FIG. 2 depicts an example system architecture including a computing device 201 in an illustrative computing environment 200 that may be used according to one or more illustrative aspects of the concepts described herein. Computing device 201 may be used as a server 206a in a single-server or multi-server desktop virtualization system (e.g., a remote access or cloud system) configured to provide virtual machines (VMs) for client access devices. Computing device 201 may have a processor 203 for controlling overall operation of the server and its associated components, including a RAM 205, a ROM 207, an input/output (I/O) module 209, and a memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices). Terminals 240 may be personal computers, mobile devices, laptop computers, tablets, or servers that include many or all the elements described above with respect to data server 103 or computing device 201. The network connections depicted in FIG. 2 include a local area network (LAN) 225 and a wide area network (WAN) 229 but may also include other networks. When used in a LAN networking environment, computing device 201 may be connected to LAN 225 through an adapter or network interface 223. When used in a WAN networking environment, computing device 201 may include a modem or other wide area network interface 227 for establishing communications over WAN 229, such as to computer network 230 (e.g., the Internet). It will be appreciated that the network connections shown are illustrative and other means of establishing a communication link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects of the concepts described herein may also be operational with numerous other general purpose or special purpose computing system environments or configurations. Examples of other computing systems, environments, and/or configurations that may be suitable for use with aspects of the concepts described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more terminals 240 may be in communication with one or more servers 206a-206n (generally referred to herein as “server(s) 206”). In one embodiment, computing environment 200 may include a network appliance installed between server(s) 206 and terminals 240. The network appliance may manage client/server connections, and in some cases can load balance client connections amongst a plurality of back-end servers 206.

Terminals 240 may in some embodiments be referred to as a single computing device or a single group of client computing devices, while server(s) 206 may be referred to as a single server 206 or a group of servers 206. In one embodiment, a single terminal 240 communicates with more than one server 206, while in another embodiment a single server 206 communicates with more than one terminal 240. In yet another embodiment, a single terminal 240 communicates with a single server 206.

Terminal 240 can, in some embodiments, be referred to as any one of the following non-exhaustive terms: client machine(s); client(s); client computer(s); client device(s); client computing device(s); local machine; remote machine; client node(s); endpoint(s); or endpoint node(s). Server 206, in some embodiments, may be referred to as any one of the following non-exhaustive terms: server(s), local machine; remote machine; server farm(s), or host computing device(s).

In one embodiment, terminal 240 may be a VM. The VM may be any VM, while in some embodiments the VM may be any VM managed by a Type 1 or Type 2 hypervisor, for example, a hypervisor developed by Citrix Systems, IBM, VMware, or any other hypervisor. In some aspects, the VM may be managed by a hypervisor, while in other aspects the VM may be managed by a hypervisor executing on server 206 or a hypervisor executing on terminal 240.

Some embodiments include a terminal, such as terminal 240, that displays application output generated by an application remotely executing on a server, such as server 206, or other remotely located machine. In these embodiments, terminal 240 may execute a VM receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

Server 206, in some embodiments, uses a remote presentation protocol or other program to send data to a thin-client or remote-display application executing on the client to present display output generated by an application executing on server 206. The thin-client or remote-display protocol can be any one of the following non-exhaustive list of protocols: the Independent Computing Architecture (ICA) protocol developed by Citrix Systems, Inc. of Fort Lauderdale, Fla.; or the Remote Desktop Protocol (RDP) manufactured by Microsoft Corporation of Redmond, Wash.

A remote computing environment may include more than one server 206a-206n logically grouped together into a server farm 206, for example, in a cloud computing environment. Server farm 206 may include servers 206a-206n that are geographically dispersed while logically grouped together, or servers 206a-206n that are located proximate to each other while logically grouped together. Geographically dispersed servers 206a-206n within server farm 206 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments, server farm 206 may be administered as a single entity, while in other embodiments server farm 206 can include multiple server farms.

In some embodiments, server farm 206 may include servers that execute a substantially similar type of operating system platform (e.g., WINDOWS, UNIX, LINUX, iOS, ANDROID, SYMBIAN, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server, a master application server, a server executing an active directory, or a server executing an application acceleration program that provides firewall functionality, application functionality, or load balancing functionality. Other server types may also be used.

Some embodiments include a first server 206a that receives requests from terminal 240, forwards the request to a second server 206b (not shown), and responds to the request generated by terminal 240 with a response from second server 206b (not shown). First server 206a may acquire an enumeration of applications available to terminal 240 as well as address information associated with an application server 206 hosting an application identified within the enumeration of applications. First server 206a can present a response to the client's request using a web interface and communicate directly with terminal 240 to provide terminal 240 with access to an identified application. One or more terminals 240 and/or one or more servers 206 may transmit data over network 230, e.g., network 101.

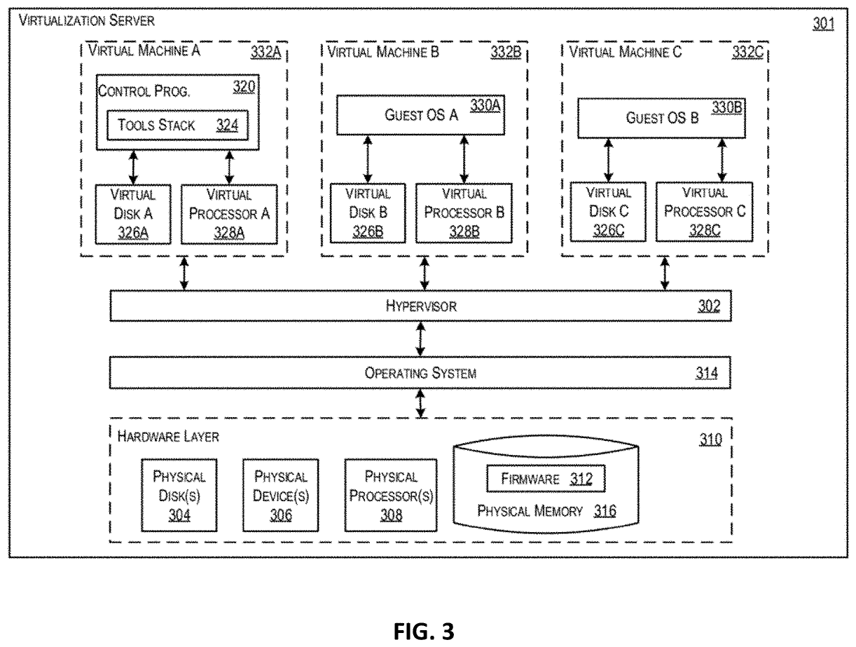

FIG. 3 shows a high-level architecture of an illustrative application virtualization system. As shown, the application virtualization system may be single-server or multi-server system, or cloud system, including at least one virtualization server 301 configured to provide virtual desktops and/or virtual applications to one or more terminals 240 (FIG. 2). As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an operating system running on a single device). Each application may be executed on a local device, or executed on a remotely located device (e.g., remoted).

A computer device may be configured as a virtualization server in a virtualization environment, for example, a single-server, multi-server, or cloud computing environment. Virtualization server 301 illustrated in FIG. 3 can be deployed as and/or implemented by one or more embodiments of server 206 illustrated in FIG. 2 or by other known computing devices. Included in virtualization server 301 is a hardware layer 310 that can include one or more physical disks 304, one or more physical devices 306, one or more physical processors 308, and one or more physical memories 316. In some embodiments, a firmware 312 can be stored within a memory element in physical memory 316 and can be executed by one or more of physical processors 308. Virtualization server 301 may further include an operating system 314 that may be stored in a memory element in physical memory 316 and executed by one or more of physical processors 308. Still further, a hypervisor 302 may be stored in a memory element in physical memory 316 and can be executed by one or more of physical processors 308.

Executing on one or more of physical processors 308 may be one or more VMs 332A-C (generally 332). Each VM 332 may have a virtual disk 326A-C and virtual processor 328A-C. In some embodiments, a first VM 332A may execute, using virtual processor 328A, a control program 320 that includes a tools stack 324. Control program 320 may be referred to as a control VM, Dom0, Domain 0, or other VM used for system administration and/or control. In some embodiments, one or more VMs 332B-C can execute, using virtual processor 328B-C, a guest operating system 330A-B.

Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in hardware layer 310 may include any type of memory. Physical memory 316 may store data, and in some embodiments may store one or more programs, or set of executable instructions. FIG. 3 illustrates an embodiment where firmware 312 is stored within physical memory 316 of virtualization server 301. Programs or executable instructions stored in physical memory 316 can be executed by the one or more processors 308 of virtualization server 301.

In some embodiments, hypervisor 302 may be a program executed by processors 308 on virtualization server 301 to create and manage any number of VMs 332. Hypervisor 302 may be referred to as a VM monitor, or platform virtualization software. In some embodiments, hypervisor 302 can be any combination of executable instructions and hardware that monitors VMs executing on a computing machine. Hypervisor 302 may be Type 2 hypervisor, where the hypervisor executes within operating system 314 executing on virtualization server 301. VMs may execute at a level above the hypervisor. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on virtualization server 301 by directly accessing the hardware and resources within hardware layer 310. That is, while a Type 2 hypervisor 302 accesses system resources through a host operating system 314, as shown, a Type 1 hypervisor may directly access all system resources without host operating system 314. A Type 1 hypervisor may execute directly on one or more physical processors 308 of virtualization server 301 and may include program data stored in physical memory 316.

Hypervisor 302, in some embodiments, can provide virtual resources to operating systems 330 or control programs 320 executing on VMs 332 in any manner that simulates operating systems 330 or control programs 320 having direct access to system resources. System resources can include, but are not limited to, physical devices 306, physical disks 304, physical processors 308, physical memory 316, and any other component included in virtualization server 301 hardware layer 310. Hypervisor 302 may be used to emulate virtual hardware, partition physical hardware, virtualize physical hardware, and/or execute VMs that provide access to computing environments. In still other embodiments, hypervisor 302 may control processor scheduling and memory partitioning for VM 332 executing on virtualization server 301. In some embodiments, virtualization server 301 may execute hypervisor 302 that creates a VM platform on which guest operating systems may execute. In these embodiments, virtualization server 301 may be referred to as a host server. An example of such a virtualization server is the Citrix Hypervisor provided by Citrix Systems, Inc., of Fort Lauderdale, Fla.

Hypervisor 302 may create one or more VMs 332B-C (generally 332) in which guest operating systems 330 execute. In some embodiments, hypervisor 302 may load a VM image to create VM 332. In other embodiments, hypervisor 302 may execute guest operating system 330 within VM 332. In still other embodiments, VM 332 may execute guest operating system 330.

In addition to creating VMs 332, hypervisor 302 may control the execution of at least one VM 332. In other embodiments, hypervisor 302 may present at least one VM 332 with an abstraction of at least one hardware resource provided by virtualization server 301 (e.g., any hardware resource available within hardware layer 310). In other embodiments, hypervisor 302 may control the way VMs 332 access physical processors 308 available in virtualization server 301. Controlling access to physical processors 308 may include determining whether VM 332 should have access to processor 308, and how physical processor capabilities are presented to VM 332.

As shown in FIG. 3, virtualization server 301 may host or execute one or more VMs 332. VM 332 is a set of executable instructions that, when executed by processor 308, may imitate the operation of a physical computer such that VM 332 can execute programs and processes much like a physical computing device. While FIG. 3 illustrates an embodiment where virtualization server 301 hosts three VMs 332, in other embodiments virtualization server 301 can host any number of VMs 332. Hypervisor 302, in some embodiments, may provide each VM 332 with a unique virtual view of the physical hardware, memory, processor, and other system resources available to that VM 332. In some embodiments, the unique virtual view can be based on one or more of VM permissions, application of a policy engine to one or more VM identifiers, a user accessing a VM, the applications executing on a VM, networks accessed by a VM, or any other desired criteria. For instance, hypervisor 302 may create one or more unsecure VMs 332 and one or more secure VMs 332. Unsecure VMs 332 may be prevented from accessing resources, hardware, memory locations, and programs that secure VMs 332 may be permitted to access. In other embodiments, hypervisor 302 may provide each VM 332 with a substantially similar virtual view of the physical hardware, memory, processor, and other system resources available to VMs 332.

Each VM 332 may include a virtual disk 326A-C (generally 326) and virtual processor 328A-C (generally 328.) Virtual disk 326, in some embodiments, is a virtualized view of one or more physical disks 304 of virtualization server 301, or a portion of one or more physical disks 304 of virtualization server 301. The virtualized view of physical disks 304 can be generated, provided, and managed by hypervisor 302. In some embodiments, hypervisor 302 provides each VM 332 with a unique view of physical disks 304. Thus, in these embodiments, the particular virtual disk 326 included in each VM 332 can be unique when compared with other virtual disks 326.

Virtual processor 328 can be a virtualized view of one or more physical processors 308 of virtualization server 301. In some embodiments, the virtualized view of physical processors 308 can be generated, provided, and managed by hypervisor 302. In some embodiments, virtual processor 328 has substantially all the same characteristics of at least one physical processor 308. In other embodiments, virtual processor 328 provides a modified view of physical processors 308 such that at least some of the characteristics of virtual processor 328 are different than the characteristics of the corresponding physical processor 308.

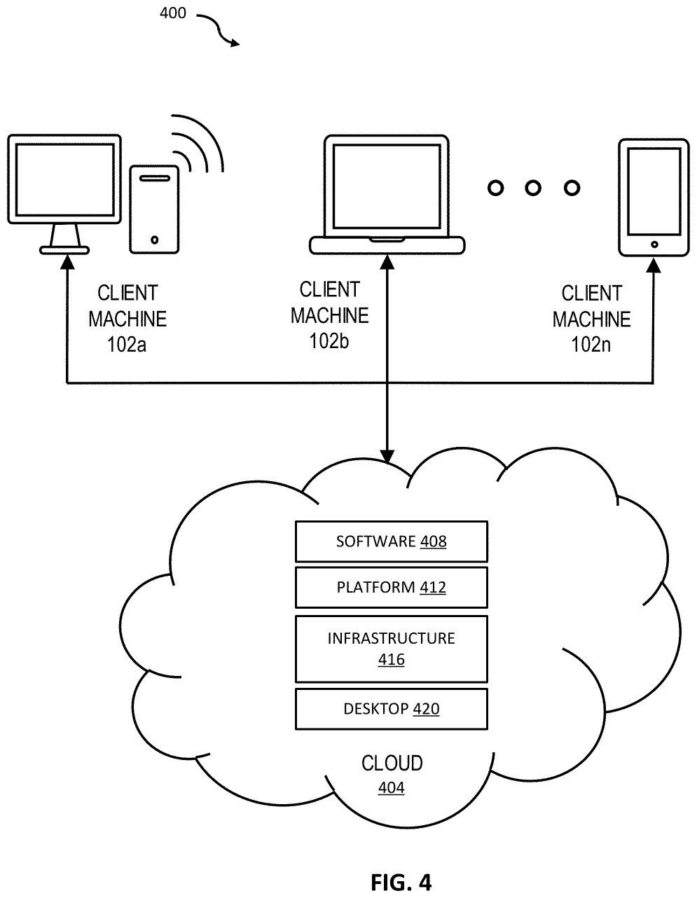

Referring to FIG. 4, a cloud computing environment 400 is depicted, which may also be referred to as a cloud environment, cloud computing or cloud network. Cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 400, one or more clients 102a-102n (such as those described above) are in communication with a cloud network 404. Cloud network 404 may include back-end platforms, e.g., servers, storage, server farms or data centers. The users or clients 102a-102n can correspond to a single organization/tenant or multiple organizations/tenants. More particularly, in one example implementation cloud computing environment 400 may provide a private cloud serving a single organization (e.g., enterprise cloud). In another example, cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 400 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 400 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 400 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 400 can provide an elasticity to dynamically scale out or scale in response to different demands from one or more clients 102. In some embodiments, cloud computing environment 400 can include or provide monitoring services to monitor, control and/or generate reports corresponding to the provided shared services and resources.

In some embodiments, cloud computing environment 400 may provide cloud-based delivery of different types of cloud computing services, such as Software as a Service (SaaS) 408, Platform as a Service (PaaS) 412, Infrastructure as a Service (IaaS) 416, and Desktop as a Service (DaaS) 420, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

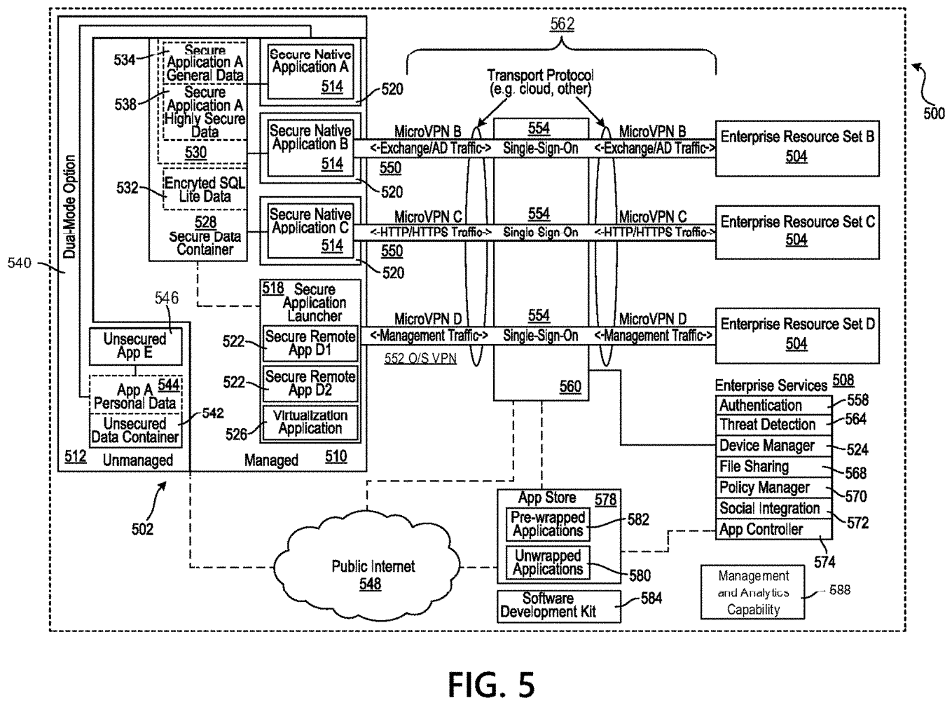

FIG. 5 depicts an illustrative enterprise mobility management system 500, in accordance with an embodiment of the present disclosure. For example, mobility management system 500 may be used in or to implement an enterprise mobile computing environment. In an example use case, mobility management system 500 enables a user of a mobile device 502 to both access enterprise or personal resources from mobile device 502 and use mobile device 502 for personal use. The user may access such enterprise resources 504 or enterprise services 508 using a mobile device 502 that is purchased by the user or a mobile device 502 that is provided by the enterprise to the user. The user may utilize mobile device 502 for business use only or for business and personal use. Mobile device 502 may run an iOS operating system, an Android operating system, or the like. The enterprise may choose to implement policies to manage mobile device 502. The policies may be implemented through a firewall or gateway in such a way that mobile device 502 may be identified, secured, or security verified, and provided selective or full access to the enterprise resources (e.g., 504 and 508). The policies may be mobile device management policies, mobile application management policies, mobile data management policies, or some combination of mobile device, application, and data management policies. A mobile device 502 that is managed through the application of mobile device management policies may be referred to as an enrolled device.

In some embodiments, the operating system of mobile device 502 may be separated into a managed partition 510 and an unmanaged partition 512. Managed partition 510 may have policies applied to it to secure the applications running on and data stored in managed partition 510. The applications running on managed partition 510 may be secure applications. In other embodiments, these applications may execute in accordance with a set of one or more policy files received separate from the application, and which define one or more security parameters, features, resource restrictions, and/or other access controls that are enforced by the mobile device management system when that application is executing on mobile device 502. By operating in accordance with their respective policy file(s), each application may be allowed or restricted from communications with one or more other applications and/or resources, thereby creating a virtual partition. Thus, as used herein, a partition may refer to a physically partitioned portion of memory (physical partition), a logically partitioned portion of memory (logical partition), and/or a virtual partition created as a result of enforcement of one or more policies and/or policy files across multiple applications as described herein (virtual partition). Stated differently, by enforcing policies on managed applications, those applications may be restricted to only be able to communicate with other managed applications and trusted enterprise resources, thereby creating a virtual partition that is not accessible by unmanaged applications and devices.

The secure applications may be email applications, web browsing applications, software-as-a-service (SaaS) access applications, Windows Application access applications, and the like. The secure applications may be secure native applications 514, secure remote applications 522 executed by a secure application launcher 518, virtualization applications 526 executed by a secure application launcher 518, and the like. Secure native applications 514 may be wrapped by a secure application wrapper 520. Secure application wrapper 520 may include integrated policies that are executed on mobile device 502 when secure native application 514 is executed on mobile device 502. Secure application wrapper 520 may include metadata that points secure native application 514 running on mobile device 502 to the resources hosted at the enterprise (e.g., 504 and 508) that secure native application 514 may require to complete the task requested upon execution of secure native application 514. Secure remote applications 522 executed by a secure application launcher 518 may be executed within secure application launcher 518. Virtualization applications 526 executed by secure application launcher 518 may utilize resources on mobile device 502, at enterprise resources 504, and the like. The resources used on mobile device 502 by virtualization applications 526 executed by secure application launcher 518 may include user interaction resources, processing resources, and the like. The user interaction resources may be used to collect and transmit keyboard input, mouse input, camera input, tactile input, audio input, visual input, gesture input, and the like. The processing resources may be used to present a user interface, process data received from enterprise resources 504, and the like. The resources used at enterprise resources 504 by virtualization applications 526 executed by secure application launcher 518 may include user interface generation resources, processing resources, and the like. The user interface generation resources may be used to assemble a user interface, modify a user interface, refresh a user interface, and the like. The processing resources may be used to create information, read information, update information, delete information, and the like. For example, virtualization application 526 may record user interactions associated with a graphical user interface (GUI) and communicate them to a server application where the server application uses the user interaction data as an input to the application operating on the server. In such an arrangement, an enterprise may elect to maintain the application on the server side as well as data, files, etc. associated with the application. While an enterprise may elect to “mobilize” some applications in accordance with the principles herein by securing them for deployment on mobile device 502, this arrangement may also be elected for certain applications. For example, while some applications may be secured for use on mobile device 502, others might not be prepared or appropriate for deployment on mobile device 502 so the enterprise may elect to provide the mobile user access to the unprepared applications through virtualization techniques. As another example, the enterprise may have large complex applications with large and complex data sets (e.g., material resource planning applications) where it would be very difficult, or otherwise undesirable, to customize the application for mobile device 502 so the enterprise may elect to provide access to the application through virtualization techniques. As yet another example, the enterprise may have an application that maintains highly secured data (e.g., human resources data, customer data, engineering data) that may be deemed by the enterprise as too sensitive for even the secured mobile environment so the enterprise may elect to use virtualization techniques to permit mobile access to such applications and data. An enterprise may elect to provide both fully secured and fully functional applications on mobile device 502 as well as virtualization application 526 to allow access to applications that are deemed more properly operated on the server side. In an embodiment, virtualization application 526 may store some data, files, etc. on mobile device 502 in one of the secure storage locations. An enterprise, for example, may elect to allow certain information to be stored on mobile device 502 while not permitting other information.

In connection with virtualization application 526, as described herein, mobile device 502 may have virtualization application 526 that is designed to present GUIs and then record user interactions with the GUI. Virtualization application 526 may communicate the user interactions to the server side to be used by the server side application as user interactions with the application. In response, the application on the server side may transmit back to mobile device 502 a new GUI. For example, the new GUI may be a static page, a dynamic page, an animation, or the like, thereby providing access to remotely located resources.

Secure applications 514 may access data stored in a secure data container 528 in managed partition 510 of mobile device 502. The data secured in the secure data container may be accessed by secure native applications 514, secure remote applications 522 executed by secure application launcher 518, virtualization applications 526 executed by secure application launcher 518, and the like. The data stored in secure data container 528 may include files, databases, and the like. The data stored in secure data container 528 may include data restricted to a specific secure application 530, shared among secure applications 532, and the like. Data restricted to a secure application may include secure general data 534 and highly secure data 538. Secure general data may use a strong form of encryption such as Advanced Encryption Standard (AES) 128-bit encryption or the like, while highly secure data 538 may use a very strong form of encryption such as AES 256-bit encryption. Data stored in secure data container 528 may be deleted from mobile device 502 upon receipt of a command from device manager 524. The secure applications (e.g., 514, 522, and 526) may have a dual-mode option 540. Dual mode option 540 may present the user with an option to operate the secured application in an unsecured or unmanaged mode. In an unsecured or unmanaged mode, the secure applications may access data stored in an unsecured data container 542 on unmanaged partition 512 of mobile device 502. The data stored in an unsecured data container may be personal data 544. The data stored in unsecured data container 542 may also be accessed by unsecured applications 546 that are running on unmanaged partition 512 of mobile device 502. The data stored in unsecured data container 542 may remain on mobile device 502 when the data stored in secure data container 528 is deleted from mobile device 502. An enterprise may want to delete from mobile device 502 selected or all data, files, and/or applications owned, licensed or controlled by the enterprise (enterprise data) while leaving or otherwise preserving personal data, files, and/or applications owned, licensed or controlled by the user (personal data). This operation may be referred to as a selective wipe. With the enterprise and personal data arranged in accordance to the aspects described herein, an enterprise may perform a selective wipe.

Mobile device 502 may connect to enterprise resources 504 and enterprise services 508 at an enterprise, to public Internet 548, and the like. Mobile device 502 may connect to enterprise resources 504 and enterprise services 508 through virtual private network connections. The virtual private network connections, also referred to as microVPN or application-specific VPN, may be specific to particular applications (as illustrated by microVPNs 550, particular devices, particular secured areas on the mobile device (as illustrated by O/S VPN 552), and the like. For example, each of the wrapped applications in the secured area of mobile device 502 may access enterprise resources through an application specific VPN such that access to the VPN would be granted based on attributes associated with the application, possibly in conjunction with user or device attribute information. The virtual private network connections may carry Microsoft Exchange traffic, Microsoft Active Directory traffic, HyperText Transfer Protocol (HTTP) traffic, HyperText Transfer Protocol Secure (HTTPS) traffic, application management traffic, and the like. The virtual private network connections may support and enable single-sign-on authentication processes 554. The single-sign-on processes may allow a user to provide a single set of authentication credentials, which are then verified by an authentication service 558. Authentication service 558 may then grant to the user access to multiple enterprise resources 504, without requiring the user to provide authentication credentials to each individual enterprise resource 504.

The virtual private network connections may be established and managed by an access gateway 560. Access gateway 560 may include performance enhancement features that manage, accelerate, and improve the delivery of enterprise resources 504 to mobile device 502. Access gateway 560 may also re-route traffic from mobile device 502 to public Internet 548, enabling mobile device 502 to access publicly available and unsecured applications that run on public Internet 548. Mobile device 502 may connect to the access gateway via a transport network 562. Transport network 562 may use one or more transport protocols and may be a wired network, wireless network, cloud network, local area network, metropolitan area network, wide area network, public network, private network, and the like.

Enterprise resources 504 may include email servers, file sharing servers, SaaS applications, Web application servers, Windows application servers, and the like. Email servers may include Exchange servers, Lotus Notes servers, and the like. File sharing servers may include ShareFile servers, and the like. SaaS applications may include Salesforce, and the like. Windows application servers may include any application server that is built to provide applications that are intended to run on a local Windows operating system, and the like. Enterprise resources 504 may be premise-based resources, cloud-based resources, and the like. Enterprise resources 504 may be accessed by mobile device 502 directly or through access gateway 560. Enterprise resources 504 may be accessed by mobile device 502 via transport network 562.

Enterprise services 508 may include authentication services 558, threat detection services 564, device manager services 524, file sharing services 568, policy manager services 570, social integration services 572, application controller services 574, and the like. Authentication services 558 may include user authentication services, device authentication services, application authentication services, data authentication services, and the like. Authentication services 558 may use certificates. The certificates may be stored on mobile device 502, by enterprise resources 504, and the like. The certificates stored on mobile device 502 may be stored in an encrypted location on mobile device 502, the certificate may be temporarily stored on mobile device 502 for use at the time of authentication, and the like. Threat detection services 564 may include intrusion detection services, unauthorized access attempt detection services, and the like. Unauthorized access attempt detection services may include unauthorized attempts to access devices, applications, data, and the like. Device management services 524 may include configuration, provisioning, security, support, monitoring, reporting, and decommissioning services. File sharing services 568 may include file management services, file storage services, file collaboration services, and the like. Policy manager services 570 may include device policy manager services, application policy manager services, data policy manager services, and the like. Social integration services 572 may include contact integration services, collaboration services, integration with social networks such as Facebook, Twitter, and LinkedIn, and the like. Application controller services 574 may include management services, provisioning services, deployment services, assignment services, revocation services, wrapping services, and the like.

Mobility management system 500 may include an application store 578. Application store 578 may include unwrapped applications 580, pre-wrapped applications 582, and the like. Applications may be populated in application store 578 from application controller 574. Application store 578 may be accessed by mobile device 502 through access gateway 560, through public Internet 548, or the like. Application store 578 may be provided with an intuitive and easy to use user interface.

A software development kit 584 may provide a user the capability to secure applications selected by the user by wrapping the application as described previously in this description. An application that has been wrapped using software development kit 584 may then be made available to mobile device 502 by populating it in application store 578 using application controller 574.

Mobility management system 500 may include a management and analytics capability 588. Management and analytics capability 588 may provide information related to how resources are used, how often resources are used, and the like. Resources may include devices, applications, data, and the like. How resources are used may include which devices download which applications, which applications access which data, and the like. How often resources are used may include how often an application has been downloaded, how many times a specific set of data has been accessed by an application, and the like.

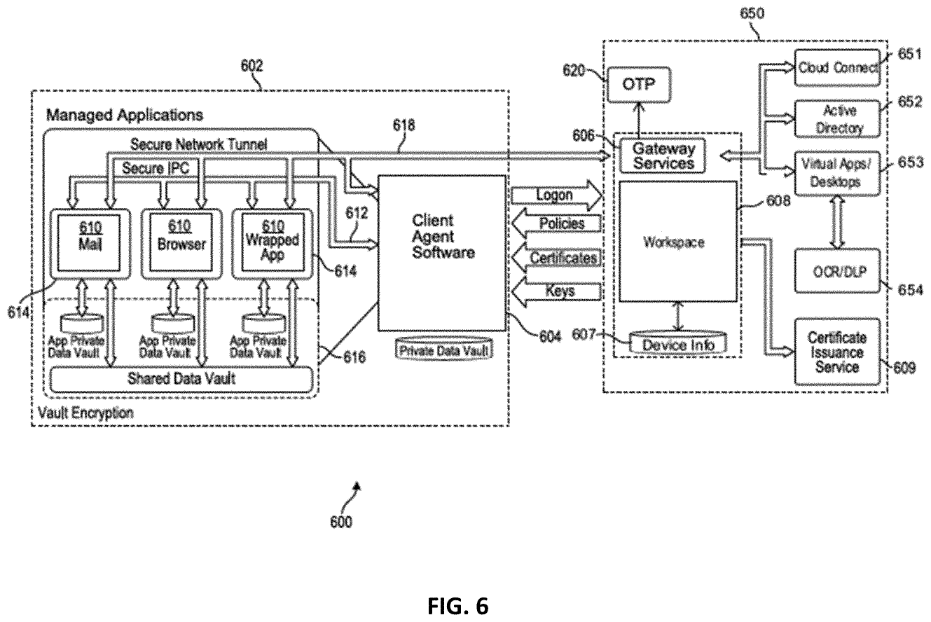

FIG. 6 depicts an illustrative enterprise computing device management system 600, in accordance with an embodiment of the present disclosure. For example, computing device management system 600 may be used in or to implement an enterprise computing environment. Some of the components of mobility management system 500 described above with reference to FIG. 5 have been omitted for the sake of simplicity. The architecture of system 600 depicted in FIG. 6 is similar in many respects to the architecture of mobility management system 500 described above with reference to FIG. 5 and may include additional features not mentioned above.

As can be seen, the left side of FIG. 6 represents an enrolled computing device 602 with a client agent 604, which interacts with a gateway server 606 (which includes Access Gateway and application controller functionality) to access various virtual apps/desktops 653 and other resources, such as an active directory (AD) 652 resource, as shown on the right side of FIG. 6. Computing device 602 may be a mobile computing device, such as mobile device 502, or a stationary (e.g., non-mobile) computing device. Examples of mobile computing devices include a smartphone, tablet, laptop computer, notebook computer, smart watch, and personal digital assistant (PDA), to name a few examples. Examples of stationary computing devices include a desktop computer, workstation, and a smart TV, to name several examples. The services and components on the right side of FIG. 6 may collectively be referred to as a sensitive content management system 650, the functions of which are described in more detail below.

Client agent 604 may act as the UI (user interface) intermediary for virtual apps/desktops 653 hosted by sensitive content management system 650, which may be accessed using the High-Definition User Experience (HDX)/ICA display remoting protocol. Client agent 604 may also support the installation and management of native applications on computing device 602, such as native WINDOWS, macOS, iOS, or ANDROID applications. For example, managed applications 610 (mail, browser, wrapped application) shown in FIG. 6 may be native applications that execute locally on computing device 602. Client agent 604 and application management framework of this architecture may act to provide policy driven management capabilities and features such as connectivity and single sign-on (SSO) to enterprise resources/services (e.g., virtual apps/desktops 653, active directory 652). Client agent 604 may handle primary user authentication to the enterprise, normally to Access Gateway (AG) 606 with SSO to other gateway server components. Client agent 604 may obtain policies from gateway server 606 to control the behavior of managed applications 610 on computing device 602.

Secure InterProcess Communication (IPC) links 612 between native applications 610 and client agent 604 represent a management channel, which may allow a client agent to supply policies to be enforced by an application management framework 614 “wrapping” each application. IPC channel 612 may also allow client agent 604 to supply credential and authentication information that enables connectivity and SSO to enterprise resources (e.g., virtual apps/desktops 653, active directory 652). In addition, IPC channel 612 may allow application management framework 614 to invoke user interface functions implemented by client agent 604, such as online and offline authentication.

Communications between client agent 604 and gateway server 606 may be essentially an extension of the management channel from application management framework 614 wrapping each native managed application 610. Application management framework 614 may request policy information from client agent 604, which in turn may request it from gateway server 606. Application management framework 614 may request authentication, and client agent 604 may log into the gateway services part of gateway server 606 (also known as NETSCALER ACCESS GATEWAY). Client agent 604 may also call supporting services on gateway server 606, which may produce input material to derive encryption keys for local data vaults 616 or may provide client certificates which may enable direct authentication to PKI protected resources, as more fully explained below.

In more detail, application management framework 614 “wraps” each managed application 610. This may be incorporated via an explicit build operation or step, or via a post-build processing operation or step. Application management framework 614 may “pair” with client agent 604 on first launch of an application 610 to initialize secure IPC channel 612 and obtain the policy for that application. Application management framework 614 may enforce relevant portions of the policy that apply locally, such as the client agent login dependencies and some of the containment policies that restrict how local OS services may be used, or how they may interact with managed application 610.

Application management framework 614 may use services provided by client agent 604 over secure IPC channel 612 to facilitate authentication and internal network access. Key management for the private and shared data vaults 616 (containers) may be also managed by appropriate interactions between managed applications 610 and client agent 604. Vaults 616 may be available only after online authentication or may be made available after offline authentication if allowed by policy. First use of vaults 616 may require online authentication, and offline access may be limited to at most the policy refresh period before online authentication is again required.

Network access to internal resources may occur directly from individual managed applications 610 through Access Gateway 606. Application management framework 614 may be responsible for orchestrating the network access on behalf of each managed application 610. Client agent 604 may facilitate these network connections by providing suitable time limited secondary credentials obtained following online authentication. Multiple modes of network connection may be used, such as reverse web proxy connections and end-to-end VPN-style tunnels 618.

Mail and Browser managed applications 610 may have special status and may make use of facilities that might not be generally available to arbitrary wrapped applications. For example, Mail application 610 may use a special background network access mechanism that allows it to access an exchange server (not shown) over an extended period of time without requiring a full AG logon. Browser application 610 may use multiple private data vaults 616 to segregate different kinds of data.

This architecture may support the incorporation of various other security features. For example, gateway server 606 (including its gateway services) in some cases may not need to validate active directory (AD) passwords. It can be left to the discretion of an enterprise whether an AD password may be used as an authentication factor for some users in some situations. Different authentication methods may be used if a user is online or offline (i.e., connected or not connected to a network).

Step up authentication is a feature wherein gateway server 606 may identify managed native applications 610 that are allowed to have access to highly classified data requiring strong authentication, and ensure that access to these applications is only permitted after performing appropriate authentication, even if this means a re-authentication is required by the user after a prior weaker level of login.

Another security feature of this solution is the encryption of data vaults 616 (containers) on computing device 602. Vaults 616 may be encrypted so that all on-device data including files, databases, and configurations are protected. For on-line vaults, the keys may be stored on a server (e.g., gateway server 606), and for off-line vaults, a local copy of the keys may be protected by a user password or biometric validation. If or when data is stored locally on computing device 602 in secure container 616, a minimum of AES 256 encryption algorithm may be utilized, although other suitable encryption algorithms may be used.

Other secure container features may also be implemented. For example, a logging feature may be included, wherein security events happening inside managed application 610 may be logged and reported to the backend. Data wiping may be supported, such as if or when managed application 610 detects tampering, associated encryption keys may be written over with random data, leaving no hint on the file system that user data was destroyed. Screenshot protection may be another feature, where an application may prevent any data from being stored in screenshots. For example, the key window's hidden property may be set to YES. This may cause whatever content is currently displayed on the screen to be hidden, resulting in a blank screenshot where any content would normally reside.

Local data transfer may be prevented, such as by preventing any data from being locally transferred outside the application container, e.g., by copying it or sending it to an external application. A keyboard cache feature may operate to disable the autocorrect functionality for sensitive text fields. SSL certificate validation may be operable so the application specifically validates the server SSL certificate instead of it being stored in the keychain. An encryption key generation feature may be used such that the key used to encrypt data on computing device 602 is generated using a passphrase or biometric data supplied by the user (if offline access is required). It may be XORed with another key randomly generated and stored on the server side if offline access is not required. Key Derivation functions may operate such that keys generated from the user password use KDFs (key derivation functions, notably Password-Based Key Derivation Function 2 (PBKDF2)) rather than creating a cryptographic hash of it. The latter makes a key susceptible to brute force or dictionary attacks.

Further, one or more initialization vectors may be used in encryption methods. An initialization vector can cause multiple copies of the same encrypted data to yield different cipher text output, preventing both replay and cryptanalytic attacks. This can also prevent an attacker from decrypting any data even with a stolen encryption key. Further, authentication then decryption may be used, wherein application data is decrypted only after the user has authenticated within the application. Another feature may relate to sensitive data in memory, which may be kept in memory (and not in disk) only when it's needed. For example, login credentials may be wiped from memory after login, and encryption keys and other data inside objective-C instance variables are not stored, as they may be easily referenced. Instead, memory may be manually allocated for these.

An inactivity timeout may be implemented, wherein after a policy-defined period of inactivity, a user session is terminated.

Data leakage from application management framework 614 may be prevented in other ways. For example, if or when a managed application 610 is put in the background, the memory may be cleared after a predetermined (configurable) time period. When backgrounded, a snapshot may be taken of the last displayed screen of the application to fasten the foregrounding process. The screenshot may contain confidential data and hence should be cleared.

Another security feature may relate to the use of an OTP (one time password) 620 without the use of AD 652 password for access to one or more applications. In some cases, some users do not know (or are not permitted to know) their AD password, so these users may authenticate using OTP 620 such as by using a hardware OTP system like SecurID (OTPs may be provided by different vendors also, such as Entrust or Gemalto). In some cases, after a user authenticates with a user ID, a text may be sent to the user with an OTP 620. In some cases, this may be implemented only for online use, with a prompt being a single field.

An offline password may be implemented for offline authentication for those managed applications 610 for which offline use is permitted via enterprise policy. For example, an enterprise may want StoreFront to be accessed in this manner. In this case, client agent 604 may require the user to set a custom offline password and the AD password is not used. Gateway server 606 may provide policies to control and enforce password standards with respect to the minimum length, character class composition, and age of passwords, such as described by the standard Windows Server password complexity requirements, although these requirements may be modified.

Another feature may relate to the enablement of a client side certificate for certain applications 610 as secondary credentials (for the purpose of accessing PKI protected web resources via the application management framework micro VPN feature). For example, managed application 610 may utilize such a certificate. In this case, certificate-based authentication using ActiveSync protocol may be supported, wherein a certificate from client agent 604 may be retrieved by gateway server 606 and used in a keychain. Each managed application 610 may have one associated client certificate, identified by a label that is defined in gateway server 606.

Gateway server 606 may interact with an enterprise special purpose web service to support the issuance of client certificates to allow relevant managed applications to authenticate to internal PKI protected resources.

Client agent 604 and application management framework 614 may be enhanced to support obtaining and using client certificates for authentication to internal PKI protected network resources. More than one certificate may be supported, such as to match various levels of security and/or separation requirements. The certificates may be used by Mail and Browser managed applications 610, and ultimately by arbitrary wrapped applications 610 (provided those applications use web service style communication patterns where it is reasonable for the application management framework to mediate HTTPS requests).

Application management client certificate support on iOS may rely on importing a public-key cryptography standards (PKCS) 12 BLOB (Binary Large Object) into the iOS keychain in each managed application 610 for each period of use. Application management framework client certificate support may use a HTTPS implementation with private in-memory key storage. The client certificate may not be present in the iOS keychain and may not be persisted except potentially in “online-only” data value that is strongly protected.

Mutual SSL or TLS may also be implemented to provide additional security by requiring that computing device 602 is authenticated to the enterprise, and vice versa. Virtual smart cards for authentication to gateway server 606 may also be implemented.

Another feature may relate to application container locking and wiping, which may automatically occur upon jailbreak or rooting detections, and occur as a pushed command from administration console, and may include a remote wipe functionality even when managed application 610 is not running.

A multi-site architecture or configuration of enterprise application store and an application controller may be supported that allows users to be serviced from one of several different locations in case of failure.

In some cases, managed applications 610 may be allowed to access a certificate and private key via an API (for example, OpenSSL). Trusted managed applications 610 of an enterprise may be allowed to perform specific Public Key operations with an application's client certificate and private key. Various use cases may be identified and treated accordingly, such as if or when an application behaves like a browser and no certificate access is required, if or when an application reads a certificate for “who am I,” if or when an application uses the certificate to build a secure session token, and if or when an application uses private keys for digital signing of important data (e.g. transaction log) or for temporary data encryption.

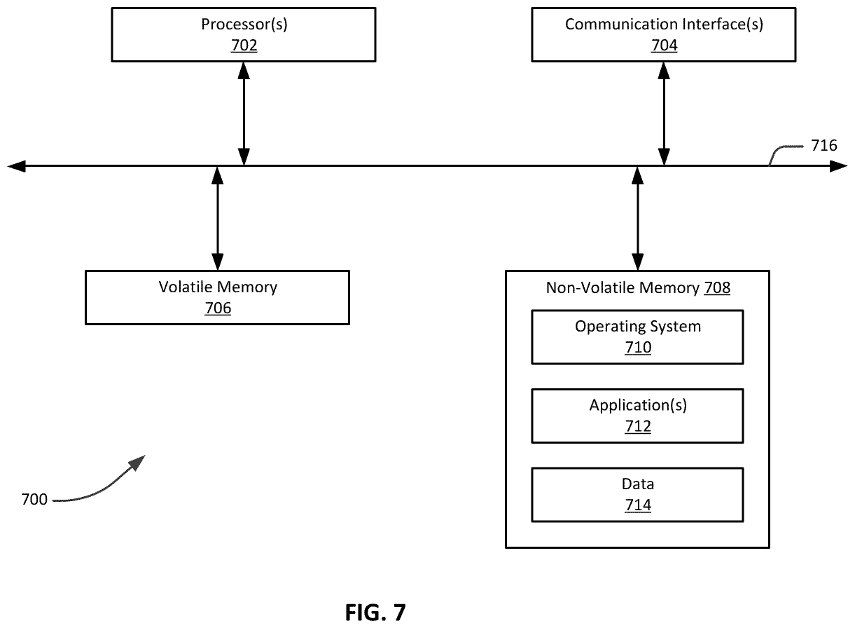

FIG. 7 is a block diagram illustrating selective components of an example computing device 700 in which various aspects of the disclosure may be implemented, in accordance with an embodiment of the present disclosure. Computing device 700 is shown merely as an example of components 103, 105, 107, and 109 of FIG. 1, computing device 201 and terminals 240 of FIG. 2, and/or client machines 102a-102n of FIG. 4, for instance. However, the illustrated computing device 700 is shown merely as an example and one skilled in the art will appreciate that components 103, 105, 107, and 109 of FIG. 1, computing device 201 and terminals 240 of FIG. 2, and/or client machines 102a-102n of FIG. 4 may be implemented by any computing or processing environment and with any type of machine or set of machines that may have suitable hardware and/or software capable of operating as described herein.

As shown in FIG. 7, computing device 700 includes one or more processor(s) 702, one or more communication interface(s) 704, a volatile memory 706 (e.g., random access memory (RAM)), a non-volatile memory 708, and a communications bus 716.

Non-volatile memory 708 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

Non-volatile memory 708 stores an operating system 710, one or more applications 712, and data 714 such that, for example, computer instructions of operating system 710 and/or applications 712 are executed by processor(s) 702 out of volatile memory 706. For example, in some embodiments, applications 712 may cause computing device 700 to implement functionality in accordance with the various embodiments and/or examples described herein. In some embodiments, volatile memory 706 may include one or more types of RAM and/or a cache memory that may offer a faster response time than a main memory. Data may be entered using an input device of computing device 700 or received from I/O device(s) communicatively coupled to computing device 700. Various elements of computing device 700 may communicate via communications bus 716.

Processor(s) 702 may be implemented by one or more programmable processors to execute one or more executable instructions, such as applications 712 and/or a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, processor 702 can be embodied in one or more application specific integrated circuits (ASICs), microprocessors, digital signal processors (DSPs), graphics processing units (CPUs), microcontrollers, field programmable gate arrays (FPGAs), programmable logic arrays (PLAs), multi-core processors, or general-purpose computers with associated memory.

Processor 702 may be analog, digital or mixed signal. In some embodiments, processor 702 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communication interface(s) 704 may include one or more interfaces to enable computing device 700 to access a computer network such as a Local Area Network (LAN), a Wide Area Network (WAN), a Personal Area Network (PAN), or the Internet through a variety of wired and/or wireless connections, including cellular connections.

In described embodiments, computing device 700 may execute an application on behalf of a user of a client device. For example, computing device 700 may execute one or more virtual machines managed by a hypervisor. Each virtual machine may provide an execution session within which applications execute on behalf of a user or a client device, such as a hosted desktop session. Computing device 700 may also execute a terminal services session to provide a hosted desktop environment. Computing device 700 may provide access to a remote computing environment including one or more applications, one or more desktop applications, and one or more desktop sessions in which one or more applications may execute.

For example, in some embodiments, a first computing device 700 may execute an application on behalf of a user of a client computing device (e.g., client 107 or 109 of FIG. 1), may execute a VM, which provides an execution session within which applications execute on behalf of a user or a client computing device (e.g., any of client machines 102a-102n of FIG. 4), such as a hosted desktop session, may execute a terminal services session to provide a hosted desktop environment, or may provide access to a computing environment including one or more of: one or more applications, one or more desktop applications, and one or more desktop sessions in which one or more applications may execute.

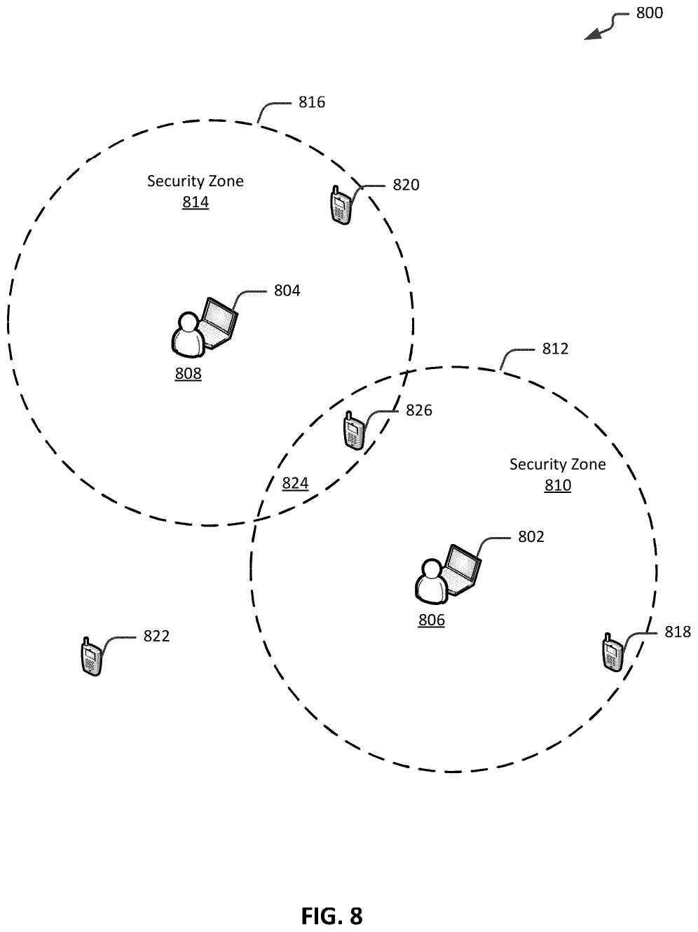

Referring to FIG. 8, in accordance with an embodiment of the present disclosure, illustrated is an example computing environment 800 in which context-aware sensitive content leak prevention may be implemented. In embodiments, environment 800 may correspond to any of the computing and/or networking environments described above in conjunction with any of FIGS. 1-7 and/or combinations thereof. As shown in FIG. 8, environment 800 may include client devices 802 and 804.

Environment 800 may be implemented by one or more organizations, such as, companies, enterprises, firms, associations, governments, and agencies, to provide context-aware sensitive content leak prevention. For example, an organization may allow its users (such as employees, contractors, agents, partners, or other users associated with the organization) to access various types of content, including access to sensitive content. To this end, the users may be assigned to or associated with respective client devices. For example, as shown in FIG. 8, a user 806 may be assigned to or associated with client device 802, and a user 808 may be assigned to or associated with client device 804. While only two computing devices and two corresponding users are shown in FIG. 8 for purposes of clarity, it will be appreciated in light of this disclosure that the concepts, devices, and techniques sought to be protected herein can be applied to environments having any number of organizations, devices, and users.

In order to provide context-aware sensitive content leak prevention, in accordance with some embodiments disclosed herein, a security zone may be created or otherwise set up around a computing device that is displaying sensitive content to detect other electronic devices (e.g., computing devices) proximate the computing device. For example, as shown in FIG. 8, a security zone 810 defined by a security perimeter 812 may be created around computing device 802, and a security zone 814 defined by a security perimeter 816 may be created around computing device 804. In this regard, security perimeter 812 may serve or otherwise function as a virtual boundary for security zone 810 such that when an electronic device enters security perimeter 812, the electronic device is within security zone 810 and, accordingly, may be considered proximate computing device 802. Similarly, when an electronic device exits security perimeter 812, the electronic device is outside security zone 810 and, accordingly, may be considered as not proximate computing device 802. The manner in which a security zone is established will be described hereinbelow.

Similarly, security perimeter 816 may serve or otherwise function as a virtual boundary for security zone 814 such that when an electronic device enters security perimeter 816, the electronic device is within security zone 814 and, accordingly, may be considered proximate computing device 804. Likewise, when an electronic device exits security perimeter 816, the electronic device is outside security zone 814 and, accordingly, may be considered not proximate computing device 804. For example, as shown in FIG. 8, a device 818 is within security zone 810 and thus proximate computing device 802, and a device 820 is within security zone 814 and thus proximate computing device 804. However, devices 820 and 822 are not proximate to computing device 802, and devices 818 and 822 are not proximate to computing device 804.

In some instances, portions of security zones may overlap. For example, a portion of a first security zone may overlap a portion of a second security zone, thus creating an overlap portion between the first and second security zones. Where an overlap portion exists between two security zones, the overlap portion is a part of both security zones. For example, as shown in FIG. 8, a portion of security zone 810 and a portion of security zone 814 may overlap to create an overlap portion 824. Overlap portion 824 is a part of security zone 810 as well as a part of security zone 814. Accordingly, as can be seen in FIG. 8, a device 826 that is within overlap portion 824 is proximate to both computing device 802 and computing device 804. As will be further described below, security zones may be used, in part, to provide context-aware sensitive content leak prevention.

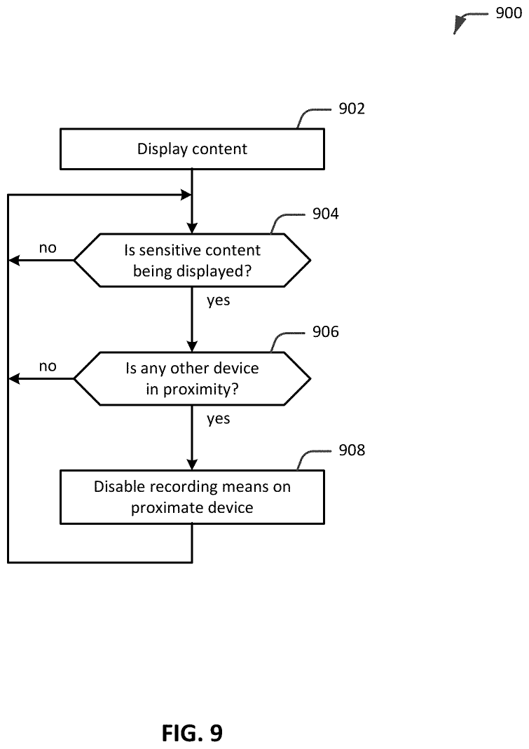

FIG. 9 is a diagram illustrating an example context-aware sensitive content leak prevention process 900, in accordance with an embodiment of the present disclosure. Process 900 may be implemented or used in a computing environment, such as environment 800 of FIG. 8. In an embodiment, process 900 may be performed by a computing device being used to display content, such as computing device 802, 804 of FIG. 8, to prevent possible leakage of sensitive content caused by electronic devices that are proximate to the computing device, such as computing device 818 and 820.

At 902, with reference to the example environment 800 of FIG. 8, user 806 may be displaying content on computing device 802. For example, user 806 may access services, such as workspace component 608 of content management system 650 of FIG. 6, and other network resources and services, using an application installed and running on computing device 802. In one example, the application may be the CITRIX WORKSPACE app, which may provide a single-entry point for accessing the organization's resources, such as applications, files, desktops, websites, etc., via virtual sessions, for example. Workspace component 608 of content management system 650 may deliver the requested content to computing device 802, and computing device 802 may be displaying the content within an application window on computing device 802.

In some cases, the display of content on computing device 802 may include audio output (e.g., sound). Examples of such content having a sound component include a podcast, webcast, such as a recorded webcast or an on-demand web cast, or other video recording. In such cases, displaying the content may generate audio output which may be recorded using an audio recording means.

At 904, computing device 802 may determine whether sensitive content is being displayed (e.g., shown) in the application window. Continuing the above example, in processing the request for the content, gateway server 606 may utilize an optical character recognition/data loss prevention (OCR/DLP) service 654 of sensitive content management system 650 to determine whether the requested content contains sensitive content. Based on the determination, gateway server 606 may provide an indication as to whether the requested content contains sensitive content to computing device 802. For example, in an implementation, OCR/DLP service 654 may set a flag that indicates whether the requested content contains sensitive content. In one such implementation, the flag may be included in the HTTP response/header via gateway server 606 or via HDX/ICA communication protocol to computing device 802. In some embodiments, computing device 802 may utilize a DLP service on the client side, such as, for example, on computing device 802, to determine whether the requested content contains sensitive content.

For example, the content may be in a text-based format (e.g., textual data) or an image-based format (e.g., an image of the content). In the case of an image, OCR/DLP service 654 may use optical character recognition (OCR) to convert the image of the content to textual data. It will be appreciated that other methods/techniques of text extraction may also be used (e.g., textual data may be embedded in the content and extracted). In any case, OCR/DLP service 654 may scan the content to identify items of sensitive content contained in the content.

In an implementation, OCR/DLP service 654 may scan the textual data for certain keywords or phrases, and/or search the textual data using regular expressions, for patterns of characters that may indicate the content includes sensitive content. Non-limiting examples of sensitive content include any data that could potentially be used to identify a particular individual (e.g., a full name, Social Security number, driver's license number, bank account number, passport number, and email address), financial information regarding an individual/organization, and information deemed confidential by the individual/organization (e.g., contracts, sales quotes, customer contact information, phone numbers, personal information about employees, and employee compensation information). Other pattern recognition techniques may be used to search for patterns of characters that may indicate the content includes sensitive content.

If it is determined that sensitive content is not being displayed in the application window, computing device 802 may continue to determine whether sensitive content is being displayed. For example, in an implementation, computing device 802 may continually and/or periodically check (e.g., every 3 sec, 4 sec, etc.) to determine whether sensitive content is being displayed in the application window. The rate or frequency with which computing device 802 checks for the display of sensitive content may be tunable or adjustable.

Otherwise, if it is determined that sensitive content is being displayed in the application window, then at 906, computing device 802 may determine whether any other electronic device is in proximity of computing device 802.

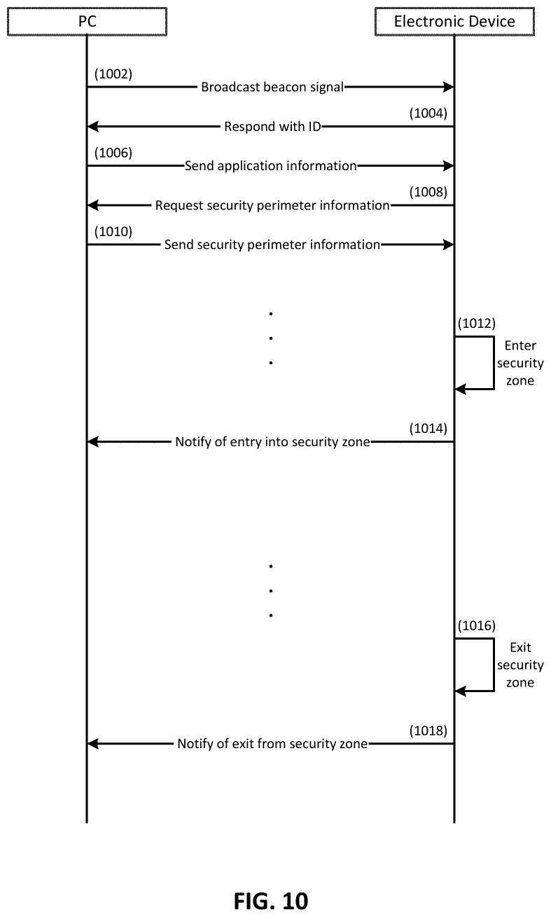

In some embodiments, security zones established using beacons, such as Bluetooth beacons or Bluetooth Low Energy beacons, may be used to detect proximate electronic devices. For example, computing device 802 may be programmed with or otherwise include an application configured to define a security zone based on beacon signal levels. In an implementation, the application may be provided on computing device 802 via a virtual desktop or session, SaaS, or other suitable service provider. In other cases, a service hub communicatively coupled to computing device 802 may define the security zone around computing device 802. In any case, the established security zone may be used to detect electronic devices proximate computing device 802. Proximity detection using beacon-based security zones is further described below at least in conjunction with FIG. 10.

Proximity detection using beacon-based security zones requires the electronic device to respond to beacon signals. For example, the electronic device may be programmed with or otherwise include an application configured to respond to the beacon signals. In an implementation, the application may be provided on the electronic device via a virtual desktop or session, SaaS, or other suitable service provider. Note that electronic devices that are not configured to respond to or detect the signals used to establish the security zone, such as, for example, the beacon signals, may not be able to detect entry into (or exit from) an established security zone.

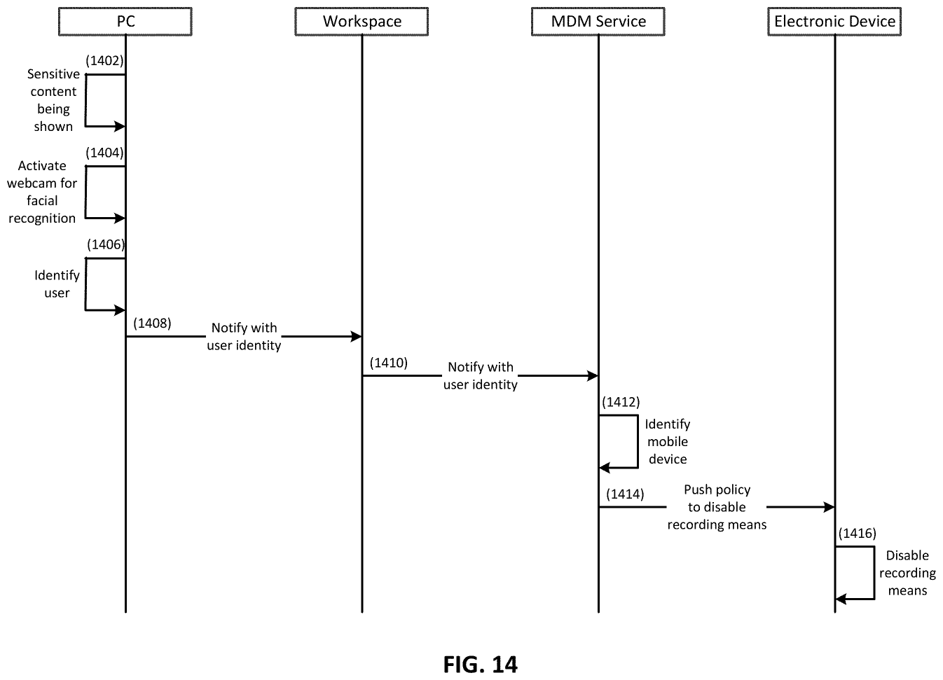

In some embodiments, machine learning models, such as computer vision and facial recognition or other suitable identification, may be used to detect proximate electronic devices and, more particularly, identify users carrying or otherwise in possession of the electronic devices. For example, in an implementation, computing device 802 may include a machine learning model trained to perform facial recognition. The machine learning model may be provided on computing device 802 via a virtual desktop or session, SaaS, or other suitable service provider. In brief, when sensitive content is being displayed, computing device 802 may trigger facial recognition using its camera, such as a webcam, and the machine learning model. Proximity detection using facial recognition in conjunction with an internal or attached camera (e.g., webcam of computing device 802) is further described below at least in conjunction with FIG. 14. Additionally or alternatively, computing device 102 may trigger person detection using its camera when sensitive content is being displayed to detect proximate electronic devices (e.g., detect proximate electronic devices being carried by or otherwise in possession of the detected person).

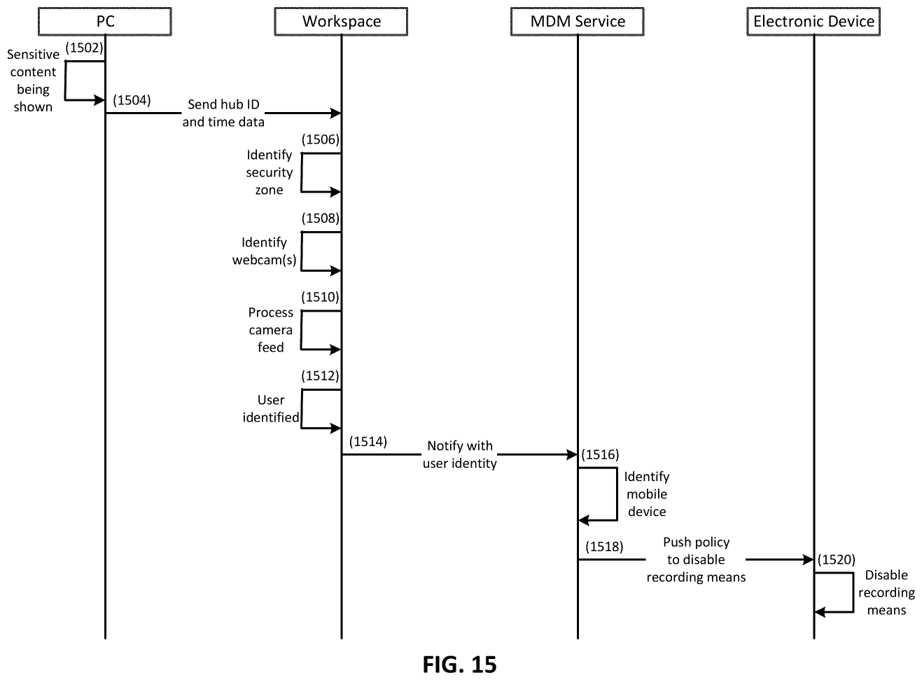

In some implementations, machine learning models may be used in conjunction with external or remote cameras to detect proximate electronic devices and, more particularly, users carrying or otherwise in possession of the electronic devices. For example, security zones may be defined or otherwise established in areas where sensitive content may be displayed and/or viewed. These areas may be locations where users may be using computing devices, such as computing device 802, to display and/or view the sensitive content. The organization can then deploy cameras, such as webcams, to monitor the security zones. For example, an administrator may use workspace component 608 to establish and monitor the security zones. Computing devices, such as computing device 802, in the security zones can then notify workspace component 608 when sensitive content is being displayed. In response, workspace component 608 may perform facial recognition using the video feeds from the cameras monitoring the security zone associated with the notifying computing device. Proximity detection using facial recognition and/or person detection in conjunction with security zone monitoring is further described below at least in conjunction with FIG. 15.

With continued reference to process 900, at 906, if it is determined that no other electronic devices are in proximity of computing device 802, then, at 904, computing device 802 may continue to determine whether sensitive content is being displayed. Additionally or alternatively, in an implementation, computing device 802 may continually and/or periodically check to determine whether any other electronic device is in proximity of computing device 802. The rate or frequency with which computing device 802 checks for another device in proximity may be tunable or adjustable. For example, computing device 802 may perform the check about every 4 seconds (sec), 5 sec, 6 sec, or any other suitable time period. The rate value may be specified by an authorized user, such as a system administrator of mobile device management system 500, for example, and pushed or otherwise provided to computing device 802.

Otherwise, if it is determined that another electronic device is in proximity of computing device 802, then, at 908, recording means, such as, for example, an image capture device, a camera, a microphone, a voice or audio recorder, or any other recording apparatus or application, on the proximate electronic device may be disabled. For example, the proximate electronic device may be an enrolled device, such as mobile device 502 of FIG. 5, that may be managed through the application of mobile device management policies. In such cases, enterprise mobility management system 500 or other suitable service may push or otherwise deliver a mobile device management policy to the proximate electronic device to disable the recording means on the electronic device. Disabling the recording means on the proximate electronic device reduces or effectively eliminates the potential for that recording means to be the cause of a data leak.

Note that the proximate electronic device may be an electronic device associated with user 806 (i.e., the user displaying the sensitive content). In this regard, disabling the recording means on an electronic device that is being carried or otherwise in the possession of user 806 may prevent user 806 from using the electronic device to record the sensitive content (e.g., capturing an image of the displayed sensitive content, generating an audio recording of the sensitive content in the case where the sensitive content includes a sound component, such as in the case of a podcast, recorded or on-demand webcast, or other video recording, etc.). In other words, disabling the recording means on an electronic device that is being carried or otherwise in the possession of user 806 prevents user 806 from being the cause of a data leak (e.g., prevents the user from becoming a rogue user).

In some cases, the proximate electronic device may not be an enrolled device. In such cases, since disabling of the recording means as described above may not be possible, other data leak prevention measures may be taken, as will be described below.

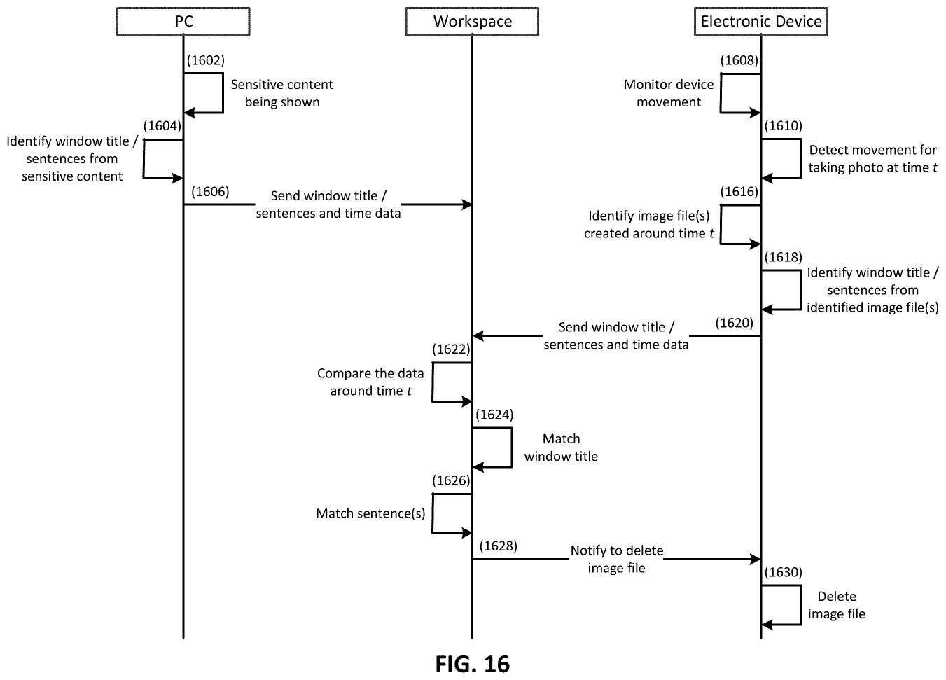

In some cases, the electronic device may include a machine learning model trained to detect use of camera based on sensor readings, such as accelerometer readings and gyroscope readings. For example, the machine learning model may be provided on the electronic device via a virtual desktop or session, SaaS, or other suitable service provider. If it is determined that the camera was used, the images taken by the camera can be processed, for example, using image processing, to determine whether an image contains the sensitive content or portions of the sensitive content. Images that contain the sensitive content or portions of the sensitive content can then be deleted or otherwise removed from the electronic device. Data leak prevention by deleting images of sensitive content is further described below at least in conjunction with FIG. 16.

In some embodiments, a computing device that is displaying sensitive content may disable its screenshot (sometimes referred to as screen capture or screen grab) functionality upon determining that an electronic device is proximate the computing device. This prevents a user from taking a digital image of the sensitive content that is being displayed on the computing device.

In some embodiments, a computing device that is displaying sensitive content may generate an alert or other notification upon determining that an electronic device is proximate the computing device. For example, the notification may provide an indication of the potential for data leak caused by the display of the sensitive content. A user displaying and/or viewing the sensitive content may then take appropriate measures to safeguard the security of the sensitive content.

In some embodiments, a computing device that is displaying sensitive content may alert or notify an authorized individual(s), such as the organization's Information Technology administrator, of the proximate electronic device and the potential for data leak. For example, the computing device may send such notification to sensitive content management system 650 or workspace component 608 of sensitive content management system 650.

FIG. 10 illustrates an example flow of interactions between various components to detect entry into and exit from a security zone, in accordance with an embodiment of the present disclosure. In particular, a computing device may provide notification of its security perimeter to allow mobile devices to determine whether the particular mobile device is entering (or exiting) a security zone defined by the security perimeter. For example, with reference to the example environment 800 of FIG. 8, computing device 802 may provide notification of its security perimeter 812 to alert or otherwise notify electronic devices, such as devices 818, 820, 822, and 826, of security zone 810.

To inform electronic devices of security zone 810, computing device 802 may broadcast (1002) a beacon signal for reception by suitable devices (e.g., electronic devices with appropriate receivers) within range of the signal. The broadcast beacon signal may include the beacon's identifying information, such as an Internet Protocol (IP) address, for communicating with the beacon and, particularly, computing device 802. Computing device 802 may periodically broadcast the beacon signals for reception within its range.

An electronic device, such as device 818, may be within range and receive the broadcast beacon signal. In response to the beacon broadcast signal, device 818 may send (1004) a response with its ID number to computing device 802. This response may be an indication that device 818 is in the range of the beacon signal (i.e., that device 818 is nearby). In response, computing device 802 may send (1006) information regarding an application (e.g., an application URL) that indicates the action to be taken by device 818. For example, the action may be to request information regarding the security perimeter associated with computing device 802. In response, device 818 may send (1008) a request for the security perimeter information to computing device 802.

In an implementation, security zone 810 may be defined using received signal strength indicator (RSSI) levels or strengths. For example, an RSSI level x may be defined for security perimeter 812 such that an RSSI level higher than x indicates presence within security zone 810 (e.g., entering security perimeter 812) and an RSSI level lower than or equal to x indicates presence outside security zone 810 (e.g., exiting security perimeter 812). In response to the request from device 818, computing device 802 may send (1010) its security zone information (e.g., the defined or threshold RSSI level x). Computing device 802 may also send an application URL that indicates an action to be taken, such as to inform computing device 802 of entering and/or exiting the indicated security perimeter. Device 818 may save the security perimeter information provided by computing device 802.

Upon receiving the security perimeter information, device 818 may start or otherwise establish a timer interval for checking the RSSI value to determine whether device 818 has entered or exited security perimeter 812. For example, at the established timer interval (e.g., when the timer interval ticks), device 818 may call a callback function to check a current RSSI value against the threshold RSSI level x (i.e., against the security perimeter information provided by computing device 802). If the current RSSI level is lower than or equal to RSSI level x, device 818 may conclude that it has not entered security perimeter 812 (and thus, is not within security zone 810). Otherwise, if the current RSSI level is higher than RSSI level x, device 818 may conclude that it has entered security perimeter 812 (and thus, is within security zone 810).

Based on a check of the current RSSI level, device 818 may determine that it has entered (1012) security perimeter 812. Upon entering security perimeter 812, device 818 may send (1014) a notification of its entering security perimeter 812 to computing device 802. For example, the notification may include identifying information regarding a user who is using device 818 (e.g., a user ID), identifying information regarding device 818 (e.g., device ID), and/or the RSSI value.

Device 818 may continue with the periodic callbacks, for example, when the established timer interval ticks. At a subsequent callback, device 818 may check a current RSSI value against the threshold RSSI level x and determine that it has exited (1016) security perimeter 812. Upon exiting security perimeter 812, device 818 may send (1018) a notification of its exiting security perimeter 812 to computing device 802.

In some embodiments, a service hub communicatively coupled to computing device 802 may define security perimeter 812 (e.g., the RSSI level) associated with security zone 810 around computing device 802. In some such embodiments, the service hub may periodically broadcast the beacon signals and communicate with electronic devices within range of the beacon signals.

In some embodiments, the security zone may be established using short-range wireless signals, such as near-field communication (NFC) signals. For example, in an implementation, computing device 802 may be programmed with or otherwise include an application configured to define a security zone based on NFC signal levels.

In some embodiments, the security zone may be established using WiFi signals. For example, in an implementation, wireless access points (WAPs) may be deployed may be deployed, for instance, within a building. The WAPs may be deployed such that a security zone includes one or more of the deployed WAPs. The WAPs may have a respective service set identifier (SSID), which may be used for identifying and connecting to the WAPs. Note that multiple WAPs may be configured to have the same SSID. The WAPs may also have a respective BSSID (the MAC address of the WAP) or ESSID (an electronic marker or identifier that serves as an identification and address of the WAP). For example, the ESSID may be generated combining a 24-bit Organization Unique Identifier (e.g., the manufacturer's identity) and the manufacturer's assigned 24-bit identifier for the radio chipset in the WAP. The BSSID/ESSID and MAC address can be combined with metadata, such as building data/identifier, floor data/identifier, and/or area data/identifier, to uniquely identify the WAPs. These identifiers can then be used to define the security zones. In an example operation of the defined security zones, an electronic device that roams within or connects to a WAP may be determined to be within the security zone associated with the WAP.

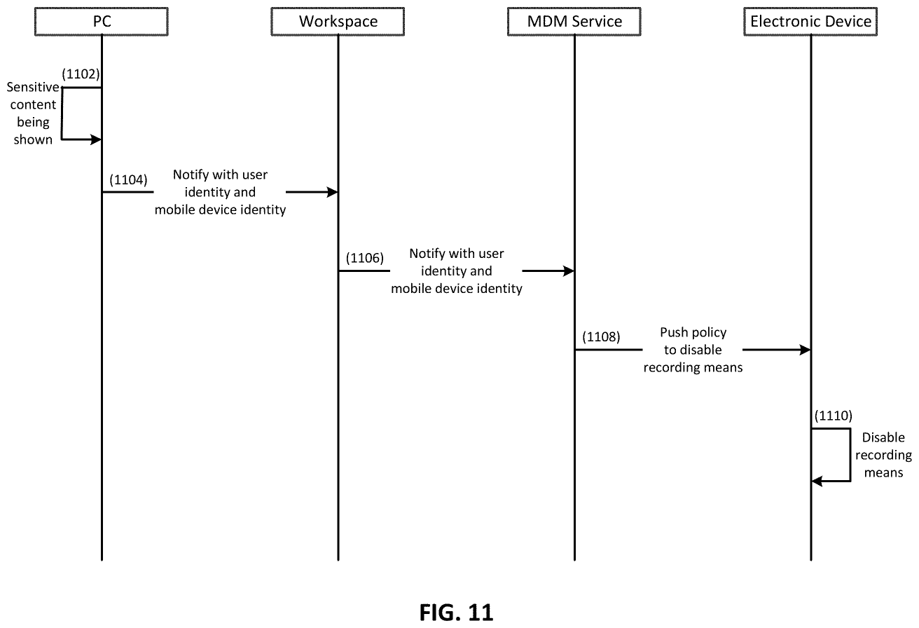

FIG. 11 illustrates an example flow of interactions between various components to disable a recording means on a device to prevent leak of sensitive content, in accordance with an embodiment of the present disclosure. For example, with reference to the example environment 800 of FIG. 8, computing device 802 may have received notification that device 818 has entered security perimeter 812. Upon receiving the notification from device 818, computing device 802 may check to determine whether sensitive content is being displayed.

As shown, computing device 802 may determine (1102) that sensitive content is being displayed. Upon determining that sensitive content is being displayed, computing device 802 may notify (1104) a service provider, such as workspace component 608, with details (e.g., user ID and device ID) regarding the presence of device 818 in security zone 810. In response to the notification from computing device 802, workspace component 608 may notify (1106) a management service that is managing device 818, such as mobile device management system 500, with details (e.g., user ID and device ID) regarding the presence of device 818 in security zone 810. Note that device 818 is an enrolled device in that device 818 may be managed through the application of mobile device management policies delivered or otherwise provided by mobile device management system 500. In response to the notification from workspace component 608, mobile device management system 500 may push (1108) to device 818 a device management policy to disable the recording means on device 818. In response to the policy, device 818 may disable (1110) its recording means, such as a camera, microphone, audio recorder, and/or other such recording means.

In cases where mobile device management system 500 is unable to identify a device management policy that corresponds to the provided user ID and device ID (e.g., has no record of the provided user ID or device ID), a notification to this effect may be provided to computing device 802. Upon receiving such notification, computing device 802 may undertake other data leak prevention measures, such as generating an alert or other notification, alert or notify an authorized individual(s), such as the organization's Information Technology administrator, and/or utilize other means to identify the user of device 818 (e.g., facial recognition).

In some embodiments, computing device 802 may communicate directly with mobile device management system 500. For example, upon determining that sensitive content is being displayed, computing device 802 may notify mobile device management system 500 with details (e.g., user ID and device ID) regarding the presence of device 818 in security zone 810.

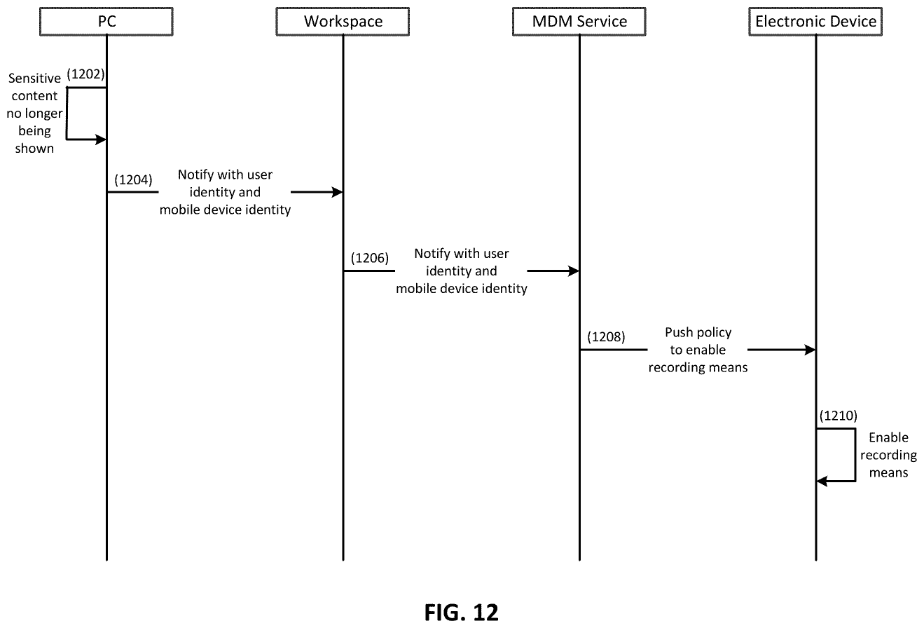

FIG. 12 illustrates an example flow of interactions between various components to enable a recording means on a device, in accordance with an embodiment of the present disclosure. For example, with reference to the example environment 800 of FIG. 8, computing device 802 may have received notification that device 818 has entered security perimeter 812 and may have caused the recording means on device 818 to be disabled. Computing device 802 may check to determine whether sensitive content is still being displayed.

As shown, computing device 802 may determine (1202) that sensitive content is not being displayed. Upon determining that sensitive content is not being displayed, computing device 802 may notify (1204) a service provider, such as workspace component 608, with details (e.g., user ID and device ID) regarding the presence of device 818 in security zone 810. In response to the notification from computing device 802, workspace component 608 may notify (1206) a management service that is managing device 818, such as mobile device management system 500, with details (e.g., user ID and device ID) regarding the presence of device 818 in security zone 810. Note that device 818 is an enrolled device in that device 818 may be managed through the application of mobile device management policies delivered or otherwise provided by mobile device management system 500. In response to the notification from workspace component 608, mobile device management system 500 may push (1208) to device 818 a device management policy to enable the disabled recording means on device 818. In response to the policy, device 818 may enable (1210) the disabled recording means.

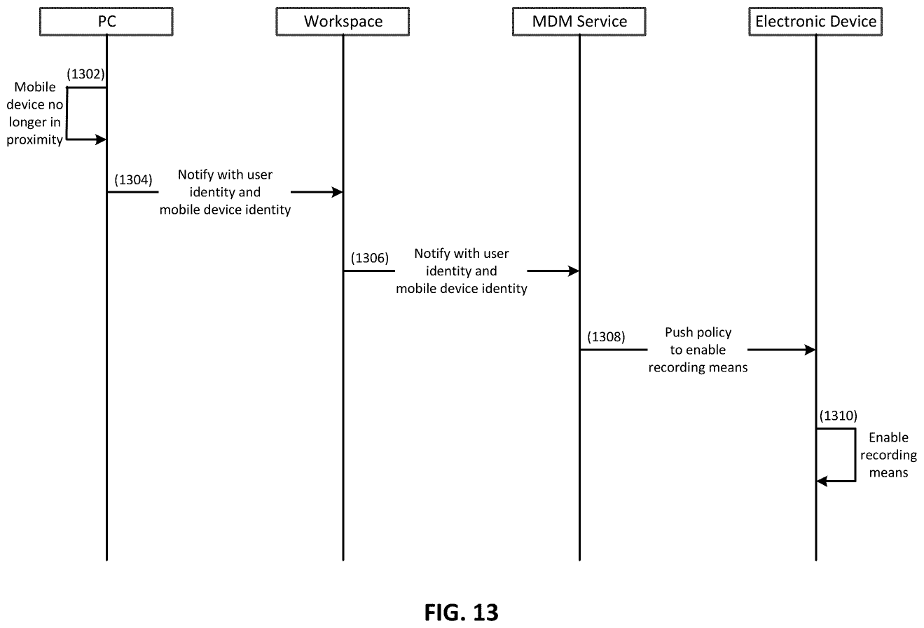

FIG. 13 illustrates an example flow of interactions between various components to enable a recording means on a device, in accordance with an embodiment of the present disclosure. For example, with reference to the example environment 800 of FIG. 8, computing device 802 may have received notification that device 818 has entered security perimeter 812 and may have caused the recording means on device 818 to be disabled.

As shown, computing device 802 may determine (1302) that device 818 is no longer proximate computing device 802. For example, computing device 802 may receive notification that device 818 exited security perimeter 812. Upon determining that device 818 is no longer proximate, computing device 802 may notify (1304) a service provider, such as workspace component 608, with details (e.g., user ID and device ID) regarding the exit of device 818 from security zone 810. In response to the notification from computing device 802, workspace component 608 may notify (1306) a management service that is managing device 818, such as mobile device management system 500, with details (e.g., user ID and device ID) regarding the exit of device 818 from security zone 810. Note that device 818 is an enrolled device in that device 818 may be managed through the application of mobile device management policies delivered or otherwise provided by mobile device management system 500. In response to the notification from workspace component 608, mobile device management system 500 may push (1308) to device 818 a device management policy to enable the disabled recording means on device 818. In response to the policy, device 818 may enable (1310) the disabled recording means.

FIG. 14 illustrates an example flow of interactions between various components to disable a recording means on a device to prevent leak of sensitive content, in accordance with an embodiment of the present disclosure. For example, with reference to the example environment 800 of FIG. 8, computing device 802 may use its camera, such as a webcam, detect a proximate electronic device.

As shown, computing device 802 may determine (1402) that sensitive content is being displayed. Upon determining that sensitive content is being displayed, computing device 802 may activate or otherwise trigger (1404) its webcam to perform facial recognition. For example, computing device 802 may include a machine learning model trained to identify the users associated with the organization. For example, the trained machine learning model may be used to identify a user from an image of the user by detecting, manipulating, and identifying the contours of the user's face in the image. The concept of facial recognition with machine learning is well understood in the fields of facial recognition, machine learning, and deep neural networks and will not be discussed in detail here. However, for purposes of this discussion, it is sufficient to understand that the trained machine learning model may operate to identify users associated with the organization (e.g., the known users) from a face(s) appearing in an image.

Computing device 802 may process the images captured by its webcam and use the trained machine learning model and identify (1406) a user. The user may be a user associated with the organization. The identified user may be considered proximate to computing device 802. Upon identifying a user from a captured image, computing device 802 may notify (1408) a service provider, such as workspace component 608, with details (e.g., user ID) regarding the identified user. In response to the notification from computing device 802, workspace component 608 may notify (1410) a management service that is managing the devices used or otherwise associated with the users of the organization, such as mobile device management system 500, with details (e.g., user ID) regarding the identified user. In response to the notification from workspace component 608, mobile device management system 500 may identify (1412) the electronic device(s) assigned to or associated with the identified user. For example, mobile device management system 500 may maintain records of users assigned to or associated with the enrolled devices. In this example case, the records may indicate that device 818 is associated with the identified user. Mobile device management system 500 may then push (1414) to device 818 a device management policy to disable the recording means on device 818. In response to the policy, device 818 may disable (1416) its recording means, such as a camera, microphone, audio recorder, and/or other such recording means.

In cases where computing device 802 is unable to identify the user, computing device 802 may undertake other data leak prevention measures, such as generating an alert or other notification upon determining that another user is proximate computing device 802 and/or alert or notify an authorized individual(s), such as the organization's Information Technology administrator, to provide a couple of examples.

FIG. 15 illustrates an example flow of interactions between various components to disable a recording means on a device to prevent leak of sensitive content, in accordance with an embodiment of the present disclosure. For example, with reference to the example environment 800 of FIG. 8, some of the organization's computing devices, such as computing devices 802, 804 and other computing devices, may be in a common, open location in a building, such as in a cubicle bay, for example. To monitor these areas, the organization can define one or more security zones, with a security zone including one or more of these computing devices. Cameras can then be deployed to monitor the security zones, and the computing devices included in the security zones. The organization may then manage the cameras (e.g., operation of the cameras) using workspace component 608 of content management system 650. For example, in an implementation, the computing devices may be communicatively coupled to workspace component 608 via service hubs with the computing devices having respective hub identifiers. The deployed cameras may also have respective identifiers. Workspace component 608 may maintain records of the particular camera(s) that are monitoring the defined security zones.

As shown, computing device 802 may determine (1502) that sensitive content is being displayed. Upon determining that sensitive content is being displayed, computing device 802 may send (1504) its identifier (e.g., hub identifier) and time data to workspace component 608. The time data indicates the time (e.g., approximate time) the sensitive content is or was detected as being displayed on computing device 802.

In response to the identifier and time data from computing device 802, workspace component 608 may identify (1506) the security zone that includes computing device 802. Workspace component 608 can then identify (1508) the camera(s) that are monitoring the identified security zone. Workspace component 608 may then process (1510) the camera feed(s) generated from the identified camera(s) at around the time indicated by computing device 802 to identify any user that may appear in the images produced by the identified cameras. For example, workspace component 802 may include a machine learning model trained to identify the users associated with the organization. The trained machine learning model may operate to identify users associated with the organization (e.g., the known users) from a face(s) appearing in an image.

Workspace component 608 may process the images produced by the identified camera(s) using the trained machine learning model and identify (1512) a user. Workspace component 608 may then notify (1514) a management service that is managing the devices used or otherwise associated with the users of the organization, such as mobile device management system 500, with details (e.g., user ID) regarding the identified user. In response to the notification from workspace component 608, mobile device management system 500 may identify (1516) the electronic device(s) assigned to or associated with the identified user. For example, mobile device management system 500 may maintain records of users assigned to or associated with the enrolled devices. In this example case, the records may indicate that device 826 is associated with the identified user. Mobile device management system 500 may then push (1518) to device 826 a device management policy to disable the recording means on device 826. In response to the policy, device 826 may disable (1520) its recording means, such as a camera, microphone, audio recorder, and/or other such recording means.

FIG. 16 illustrates an example flow of interactions between various components to delete a file storing an image of sensitive content on a device to prevent leak of sensitive content, in accordance with an embodiment of the present disclosure. For example, it may be that a computing device is used in a location within an organization's facility that is not monitored by beacons and/or cameras. In such cases, it may be possible to detect camera use on electronic devices that are running applications managed by a service provider, such as workspace component 608, and delete or otherwise cause the deletion of any images of sensitive content taken using the camera.

As shown, a computing device, such as computing device 802 of FIG. 8, may determine (1602) that sensitive content is being displayed. The sensitive content may be displayed within an application window on computing device 802. Upon determining that sensitive content is being displayed, computing device 802 may identify (1604) the window title or so-called window tag associated with the application window (e.g., the text that appears at the top of the application window) and one or more texts, words, and/or sentences form the sensitive content. The texts, words, and/or may be suitable for identifying the displayed sensitive content. Computing device 802 may then send (1606) the window title, identified one or more texts, words, and/or sentences from the sensitive content, and time data to workspace component 608. The time data indicates the time (e.g., approximate time) the sensitive content is or was detected as being displayed on computing device 802. Workspace component 608 may then use the data provided by computing device 802 to identify any images of the sensitive content taken using a camera of an electronic device that may have been proximate computing device 802 around the time the sensitive content is or was displayed. In some embodiments, computing device 802 may also provide its location information (e.g., approximate location information such as building number, address, city, etc.) to workspace component 608. Workspace component 608 may then use the provided location information to identify any images of the sensitive content.

An electronic device, such as device 818 of FIG. 8, may monitor (1608) its movement. For example, device 818 may be being held and used by a user who is near computing device 802. Note that the user of device 818 may not be located near computing device 802. For example, device 818 may include a machine learning model trained to detect use of a camera or camera function on device 818. For example, the trained machine learning model may be used to detect whether a camera is used based on sensor readings, such as accelerometer readings and gyroscope readings, from device 818. However, for purposes of this discussion, it is sufficient to understand that the trained machine learning model may operate to detect use of a camera on an electronic device based on the electronic device's sensor readings.

Device 818 may detect (1610) the use of its camera. Upon detecting the use of its camera, device 818 may record a time (e.g., approximate time), t, the camera use is or was detected. Device 818 may then monitor the creation of image files on device 818 to identify images files created around time t. Based on the monitoring, device 818 may identify (1616) an image file(s) created around time t. Device 818 may then identify (1618) any window titles that may appear in the image(s) associated with the identified image file(s). Device 818 may also identify one or more texts, words, and/or sentences form the image(s) associated with the identified image file(s). For example, the data from the images (e.g., window title, texts, words, and/or sentences) may be identified using OCR and image processing. Device 818 may then send (1620) the identified window titles, the identified one or more texts, words, and/or sentences, and time data (e.g., time data indicating the respective times the image(s) were taken or image file(s) created) to workspace component 608. Device 818 may also send its identifier (e.g., device ID). In some embodiments, device 818 also provide its location information (e.g., approximate location information such as building number, address, city, etc.) to workspace component 608.

In response to the data from device 818, workspace component 608 may compare (1622) the data (the window titles and one or more texts, words, and/or sentences provided by computing device 802 to the window titles and one or more texts, words, and/or sentences provided by device 818) and around time t. The compared data is the data associated with time t, which is the time (e.g., approximate time) of the camera use on device 818. In cases where location information is received from computing device 802 and device 818, workspace component 608 may compare the data based on the provided location information.

In an implementation, workspace component 608 may first compare window titles to determine whether there is a match of window titles. If there is a match of window titles, workspace component 608 may then compare the texts, words, and/or sentences to determine whether there is a match. In an implementation, a 100% match of the texts, words, and/or sentences provided by device 818 is not required. In other words, not all the texts, words, and/or sentences provided by device 818 need to be found to conclude that there is a match. For example, suppose device 818 identifies Window Title X and Sentence A, Sentence B, and Sentence C in an image, and sends Window Title X and Sentences A, B, and C to workspace component 608. Workspace component 608 may search the data provided by computing device 802 for Window Title X. If Window Title X is matched (i.e., found in the data provided by computing device 802), then workspace component 608 may compare Sentence A, Sentence B, and Sentence C with the one or more texts, words, and/or sentences associated with Window Title X provided by computing device 802. In this example case, workspace component 608 may conclude that there is a match (i.e., a match between the texts, words, and/or sentences provided by device 818 and the texts, words, and/or sentences provided by computing device 802) if any one or more of Sentence A, Sentence B, and Sentence C is found in the texts, words, and/or sentences provided by computing device 802. For the title, workspace component 608 may conclude that there is a match between the titles if a threshold percentage (e.g., 75%, 80%, 85%, 90%, or other suitable percentage) of the text in the title match. In cases where the title appears or is in color or colors (e.g., color is associated with the title) a match in the color may be needed to conclude that there is a match between titles.

Based on a comparison of the data around time t, workspace component 608 may identify (1624) a match of window titles and a match (1626) of the texts, words, and/or sentences. Workspace component 608 may then notify (1628) device 818 to delete the image file(s) containing image(s) of the matched window title and texts, words, and/or sentences. In response, device 818 may delete (1630) the image file(s) that contain such image(s).

In some embodiments, other factors, such as icons appearing in the application window, may be considered in identifying an image file storing an image of sensitive content.

As will be further appreciated in light of this disclosure, with respect to the processes, methods, and interactions disclosed herein, the functions performed in the processes, methods, and interactions may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
responsive to a determination that sensitive content is being displayed on a first device, determining, by the first device, whether a second device is proximate the first device, the second device having at least one recording means; and
responsive to a determination that the second device is proximate the first device, causing, by the first device, disabling of the at least one recording means on the second device to thereby prevent the sensitive content from being recorded using the at least one recording means of the second device.

2. The method of claim 1, wherein the at least one recording means includes a camera.

3. The method of claim 1, wherein the at least one recording means includes an audio recorder.

4. The method of claim 1, wherein determining whether the second device is proximate the first device includes determining whether the second device is within a security zone associated with the first device.

5. The method of claim 1, wherein determining whether the second device is proximate the first device includes determining whether a user of the second device is proximate the first device using facial recognition.

6. The method of claim 1, further comprising, responsive to a determination that the second device is no longer proximate the first device, causing enabling of the at least one recording means on the second device.

7. A system comprising:
a memory; and
one or more processors in communication with the memory and configured to,
responsive to a determination that sensitive content is being displayed on a first device, determine whether a second device is proximate the first device, the second device having at least one recording means; and
responsive to a determination that the second device is proximate the first device, cause the at least one recording means on the second device to be disabled to thereby prevent the sensitive content from being recorded using the at least one recording means of the second device.

8. The system of claim 7, wherein the at least one recording means includes one of a camera, an audio recorder, or an image capture device.

9. The system of claim 7, wherein the second device is a mobile device.

10. The system of claim 7, wherein to determine whether the second device is proximate the first device includes to determine whether the second device is within a security zone associated with the first device.

11. The system of claim 7, wherein to determine whether the second device is proximate the first device includes to determine whether a user of the second device is proximate the first device via facial recognition.

12. The system of claim 7, wherein the one or more processors in communication with the memory is further configured to, responsive to a determination that the second device is no longer proximate the first device, cause the at least one recording means on the second device to be enabled.

13. A method comprising:
responsive to a determination that sensitive content is being displayed on a first device, determining, by the first device, whether a second device is proximate the first device; and
responsive to a determination that the second device is proximate the first device, preventing, by the first device, loss of the sensitive content via use of the second device.

14. The method of claim 13, wherein determining whether the second device is proximate the first device includes determining whether the second device is within a security zone associated with the first device.

15. The method of claim 13, wherein determining whether the second device is proximate the first device includes determining whether a user of the second device is proximate the first device using facial recognition.

16. The method of claim 13, wherein determining whether the second device is proximate the first device includes determining whether a camera of the second device is used based on machine learning.

17. The method of claim 13, wherein the second device has at least one recording means, and wherein preventing loss of the sensitive content includes causing disabling of the at least one recording means on the second device to thereby prevent the sensitive content from being recorded using the at least one recording means of the second device.

18. The method of claim 17, wherein the at least one recording means includes one of a camera or an audio recorder.

19. The method of claim 13, wherein preventing loss of the sensitive content includes deleting an image file on the second device.

20. The method of claim 13, wherein preventing loss of the sensitive content includes providing a notification on the first device.
